(19) United States
(12) Patent Application Publication
(10) Pub. No.: US 2020/0195796 A1
(43) Pub. Date: Jun. 18, 2020

(54) IMAGING SYSTEM, IMAGE FORMING APPARATUS, IMAGING APPARATUS, AND STORAGE MEDIUM

(71) Applicant: Konica Minolta, Inc., Tokyo (JP)

(72) Inventor: Keita ISHIHARA, Tokyo (JP)

(73) Assignee: Konica Minolta, Inc., Tokyo (JP)

(21) Appl. No.: 16/714,973

(22) Filed: Dec. 16, 2019

(30) Foreign Application Priority Data
Dec. 17, 2018 (JP) 2018-235768

(51) Int. Cl. H04N 1/00; H04N 1/36

(52) U.S. Cl. CPC H04N 1/00649; H04N 1/36; H04N 1/00986; H04N 1/0061

(57) ABSTRACT

Disclosed is an imaging system, which may include: an image forming apparatus including a conveyer, a sheet feeder on which recording media are exposed to an outside, a first hardware processor that causes the conveyer to convey the recording media one by one, an image former, and a first communicator; and an imaging apparatus including an imager, a second hardware processor that causes the imager to image documents one by one in accordance with a timing at which the conveyer conveys each document, the plurality of documents being the plurality of recording media loaded on the sheet feeder to be imaged, and a second communicator that communicates with the first communicator. The imaging system performs: transmission of first information for determining an imaging timing from the first communicator to the second communicator; and/or transmission of second information for determining a conveyance start timing from the second communicator to the first communicator.

### CROSS-REFERENCE TO RELATED APPLICATION

This application claims priority to Japanese Patent Application No. 2018-235768 filed on Dec. 17, 2018, which is incorporated herein by reference in its entirety.

### BACKGROUND

### Technological Field

The present disclosure relates to an imaging system, an image forming apparatus, an imaging apparatus, and a storage medium.

### Description of the Related Art

A known method simply scans a document (recording medium to be imaged) in an image forming apparatus (for example, a single function printer (SFP)) that does not have a scan function for imaging a document (function for capturing an image of a document), by attaching an imaging apparatus provided with an imager (for example, a camera and a smartphone) and causing the imaging apparatus to image the document. For example, Japanese Patent Application Publication No. 2014-131194 discloses a method that simply continuously scans a plurality of documents, by causing a conveyer of an image forming apparatus to convey the plurality of documents loaded on a manual feed tray to a sheet ejector one by one, and causing an imaging apparatus to sequentially image the documents ejected on the sheet ejector. According to this method, a conveyance time from when conveyance of a document is started to when the document is ejected to the sheet ejector is measured in advance. Then, each of the documents is imaged after a lapse of the conveyance time from the start of the conveyance of the document. In this way, it is possible to image each document when ejected to the sheet ejector.

However, the document may not be sometimes conveyed correctly due to an operation error of the conveyer, or the document may not be sometimes ejected after the lapse of the predetermined conveyance time due to a mechanical error or the like of the operation of the conveyer. In the method of imaging documents at the ejector in response to the lapse of the predetermined conveyance time to the ejector, a document may sometimes be imaged before the document is ejected to the ejector, or a document may sometimes be imaged before the movement of the ejected document stops. That is, the method suffers from difficulty in correctly imaging documents.

### SUMMARY

It is an object of the present disclosure to provide an imaging system, an image forming apparatus, an imaging apparatus, and a storage medium that facilitate correctly imaging documents.

To achieve at least one of the abovementioned objects, according to an aspect of the present disclosure, an imaging system may comprise: an image forming apparatus, including: a conveyer that conveys a recording medium; a sheet feeder on which a plurality of recording media to be fed to the conveyer is loaded such that the plurality of recording media is exposed to an outside; a first hardware processor that causes the conveyer to convey the plurality of recording media loaded on the sheet feeder one by one; an image former that forms an image on the recording medium being conveyed by the conveyer; and a first communicator; and an imaging apparatus, including: an imager; a second hardware processor that causes the imager to image a plurality of documents one by one in accordance with a timing at which the conveyer conveys each of the plurality of documents, the plurality of documents being the plurality of recording media loaded on the sheet feeder to be imaged; and a second communicator that communicates with the first communicator; wherein, when the imaging apparatus images the plurality of documents, the imaging system performs at least one of the following operations: transmission of first information for determining an imaging timing of a document by the second hardware processor, from the first communicator to the second communicator; and transmission of second information for determining a conveyance start timing of a document by the first hardware processor, from the second communicator to the first communicator.

To achieve at least one of the abovementioned objects, according to another aspect of the present disclosure, an image forming apparatus may comprise: a conveyer that conveys a recording medium; a sheet feeder on which a plurality of recording media to be fed to the conveyer is loaded such that the plurality of recording media is exposed to an outside; a first hardware processor that causes the conveyer to convey the plurality of recording media loaded on the sheet feeder one by one; an image former that forms an image on the recording medium being conveyed by the conveyer; and a first communicator, wherein the image forming apparatus is communicably connectable to an imaging apparatus, wherein the imaging apparatus includes: an imager; a second hardware processor that causes the imager to image a plurality of documents one by one in accordance with a timing at which the conveyer conveys each of the plurality of documents, the plurality of documents being the plurality of recording media loaded on the sheet feeder to be imaged; and a second communicator that communicates with the first communicator, and wherein the first hardware processor is configured to: control the first communicator; and when the imaging apparatus images the plurality of documents, cause the first communicator to perform at least one of the following operations: transmission of first information for determining an imaging timing of the document by the second hardware processor, to the second communicator; and reception of second information for determining a conveyance start timing of the document by the first hardware processor, from the second communicator.

To achieve at least one of the abovementioned objects, according to another aspect of the present disclosure, an imaging apparatus may be communicably connectable to an image forming apparatus. The image forming apparatus may include: a conveyer that conveys a recording medium; a sheet feeder on which a plurality of recording media to be fed to the conveyer is loaded such that the plurality of recording media is exposed to an outside; a first hardware processor that causes the conveyer to convey the plurality of recording media loaded on the sheet feeder one by one; an image former that forms an image on the recording medium being conveyed by the conveyer; and a first communicator. The imaging apparatus may comprise: an imager; a second hardware processor that causes the imager to image a plurality of documents one by one in accordance with a timing at which the conveyer conveys each of the plurality of documents, the plurality of documents being the plurality of recording media loaded on the sheet feeder to be imaged; and a second communicator that communicates with the first communicator, wherein the second hardware processor is configured to: control the second communicator; and when the plurality of documents are imaged, cause the second communicator to perform at least one of the following operations: reception of first information for determining an imaging timing of a document by the second hardware processor, from the first communicator; and transmission of second information for determining a conveyance start timing of a document by the first hardware processor, to the first communicator.

To achieve at least one of the abovementioned objects, according to another aspect of the present disclosure, a non-transitory computer-readable storage medium may store a program to be executed by a first hardware processor of an image forming apparatus. The image forming apparatus may include: the first hardware processor; a conveyer that conveys a recording medium; a sheet feeder on which a plurality of recording media to be fed to the conveyer is loaded such that the plurality of recording media is exposed to the outside; an image former that forms an image on the recording medium being conveyed by the conveyer; and a first communicator. The image forming apparatus may be communicably connectable to an imaging apparatus. The imaging apparatus may include: an imager; a second hardware processor that causes the imager to image a plurality of documents one by one in accordance with a timing at which the conveyer conveys each of the plurality of documents, the plurality of documents being the plurality of recording media loaded on the sheet feeder to be imaged; and a second communicator that communicates with the first communicator. The program may cause the first hardware processor to perform: causing the conveyer to convey the plurality of recording media loaded on the sheet feeder one by one; controlling the first communicator; and, when the imaging apparatus images the plurality of documents, performing predetermined processing, and wherein the processing causes the first communicator to perform at least one of following operations: transmission of first information for determining an imaging timing of a document by the second hardware processor, to the second communicator; and reception of second information for determining a conveyance start timing of a document by the first hardware processor, from the second communicator.

To achieve at least one of the abovementioned objects, according to another aspect of the present disclosure, a non-transitory computer-readable storage medium may store a program to be executed by a second hardware processor of an imaging apparatus. The imaging apparatus may include: the second hardware processor; an imager; and a second communicator, wherein the imaging apparatus is communicably connectable to an image forming apparatus, wherein the image forming apparatus includes: a conveyer that conveys a recording medium; a sheet feeder on which a plurality of recording media to be fed to the conveyer is loaded such that the plurality of recording media is exposed to an outside; a first hardware processor that causes the conveyer to convey the plurality of recording media loaded on the sheet feeder one by one; an image former that forms an image on the recording medium being conveyed by the conveyer; and a first communicator that communicates with the second communicator, wherein the program causes the second hardware processor to perform: causing the imager to image a plurality of documents one by one in accordance with a timing at which the conveyer conveys each of the plurality of documents, the plurality of documents being the plurality of recording media loaded on the sheet feeder to be imaged; controlling the second communicator; and, when the plurality of documents are imaged, performing predetermined processing, and wherein the processing causes the second communicator to perform at least one of the following operations: reception of first information for determining an imaging timing of a document by the second hardware processor, from the first communicator; and transmission of second information for determining a conveyance start timing of a document by the first hardware processor, to the first communicator.

### BRIEF DESCRIPTION OF THE DRAWING

The advantages and features provided by one or more embodiments of the disclosure will become more fully understood from the detailed description given hereinbelow and the appended drawings which are given by way of illustration only, and thus are no intended as a definition of the limits of the present disclosure, wherein:

FIG. 1 illustrates a schematic configuration of an imaging system;

FIG. 2 is a block diagram illustrating a main functional configuration of an image forming apparatus;

FIG. 3 is a block diagram illustrating a main functional configuration of an imaging terminal;

FIG. 4 is a flowchart illustrating the overview of a scan operation of an imaging system;

FIG. 5 is a flowchart illustrating the control steps of image-forming-apparatus-side scan processing;

FIG. 6 is a flowchart illustrating the control steps of pre-processing;

FIG. 7 is a flowchart illustrating the control steps of scan job reception processing;

FIG. 8 is a flowchart illustrating the control steps of document conveyance processing;

FIG. 9 is a flowchart illustrating the control steps of image-forming-apparatus-side interruption processing;

FIG. 10 is a flowchart illustrating the control steps of image-forming-apparatus-side post-processing;

FIG. 11 is a flowchart illustrating the control steps of imaging-terminal-side scan processing;

FIG. 12 is a flowchart illustrating the control steps of document imaging processing;

FIG. 13 is a flowchart illustrating the control steps of imaging-terminal-side interruption processing;

FIG. 14 is a flowchart illustrating the control steps of imaging-terminal-side post-processing;

FIG. 15 is a flowchart illustrating the overview of a scan operation according to a second embodiment; and

FIG. 16 is a flowchart illustrating the overview of a scan operation according to a third embodiment.

### DETAILED DESCRIPTION OF EMBODIMENTS

Hereinafter, embodiments of an imaging system, an imaging apparatus, an image forming apparatus, and a recording medium of the present disclosure will be described with reference to the accompanying drawings. However, the present disclosure is not limited to the embodiments disclosed below.

### First Embodiment

<Overview of Imaging System>

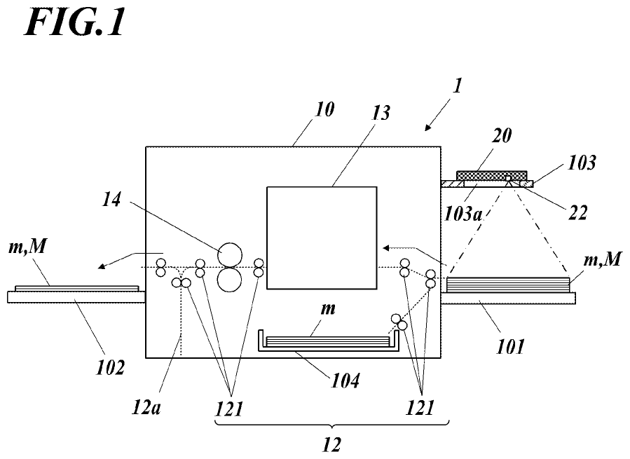

FIG. 1 illustrates a schematic configuration of an imaging system 1 according to a first embodiment of the present disclosure.

The imaging system 1 includes an image forming apparatus 10 and an imaging terminal 20 (imaging apparatus).

The image forming apparatus 10 is a printer that forms an image on a recording medium m using an electrophotographic system. The image forming apparatus 10 of the present embodiment is an SFP that does not have a function for scanning the recording medium m on which an image is formed.

The recording medium m on which an image is formed is hereinafter also referred to as a “document M”. The term “recording medium m” refers to a recording medium m on which no image is formed, or a document M.

The imaging terminal 20 is a smartphone provided with an imager 22 having an imaging element. The imaging terminal 20 is communicably connected to the image forming apparatus 10 via Near Field Communication (NFC) when placed on an adapter 103 of the image forming apparatus 10. The types of NFC that may be used include, but not limited to, Wireless Fidelity (Wi-Fi), and Bluetooth (registered trademark), for example. Also, an optical or audio communication system may be used as the communication system between the imaging terminal 20 and the image forming apparatus 10. The imaging terminal 20 is positioned in a predetermined imaging position when placed in on the adapter 103, and images the document M loaded on a manual feed tray 101 (sheet feeder) of the image forming apparatus 10, from above. It should be noted that any terminal apparatus having the imager 22, such as a camera terminal, may be used as the imaging terminal 20, in place of a smartphone.

The imaging system 1 causes the imaging terminal 20 to image a plurality of documents M loaded on the manual feed tray 101 of the image forming apparatus 10, one by one, thereby scanning the plurality of documents M. The expression “to scan” the document M usually means “to obtain image data” by detecting reflected light of the light with which the document M is scanned, using an imaging element. However, as used herein, this expression means “to image (to capture an image of)” the document M using the imaging terminal 20 so as to obtain the image data of the document M.

Specifically, an imaging operation by the imaging terminal 20 to image the uppermost document M on the manual feed tray 101 and a conveyance operation by the image forming apparatus 10 to pick up the imaged document M from the manual feed tray 101 and convey the document M to the sheet ejection tray 102 are repeated the same number of times as the number of documents M, so that the plurality of documents M are automatically scanned. Also, it is possible to make a copy of the documents M by causing the image forming apparatus 10 to form images based on imaging data obtained through scanning.

<Configuration of Image Forming Apparatus 10>

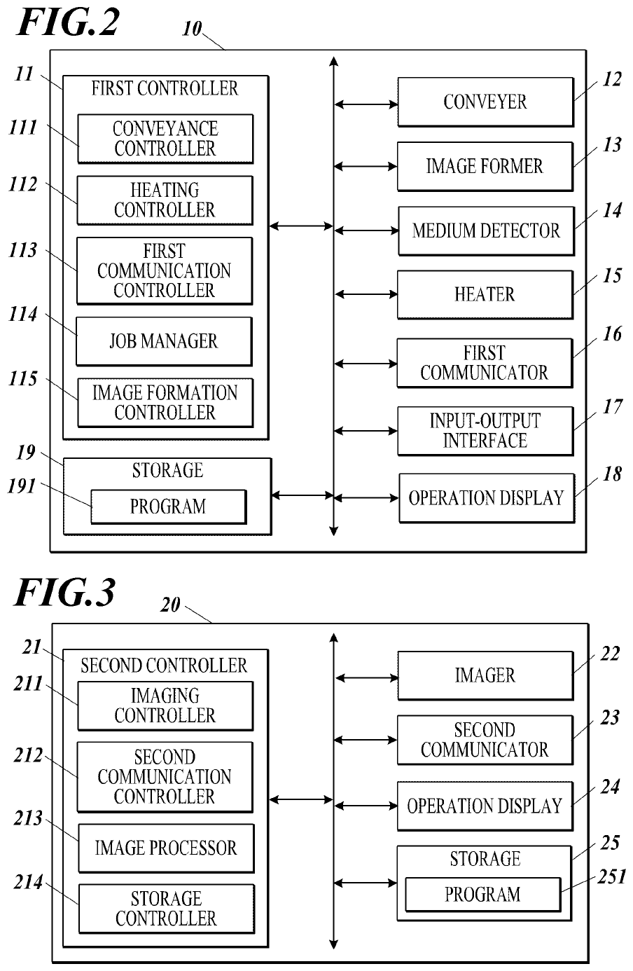

In the following, the configuration of the image forming apparatus 10 will be described with reference to FIGS. 1 and 2.

FIG. 2 is a block diagram illustrating a main functional configuration of the image forming apparatus 10.

The image forming apparatus 10 includes a first controller 11 (first hardware processor, computer), a conveyer 12, an image former 13, a medium detector 14, a heater 15, a first communicator 16, an input-output interface 17, an operation display 18, a storage (non-transitory computer-readable storage medium) 19, the manual feed tray 101, the sheet ejection tray 102 (sheet ejector), the adapter 103, and an internal sheet feed tray 104.

The conveyer 12 includes a plurality of conveyance rollers 121 that rotate while nipping the recording medium m therebetween, so as to convey the recording medium m. The conveyer 12 causes the plurality of conveyance rollers 121 to pick up the recording medium m from the manual feed tray 101 or the internal sheet feed tray 104, convey the recording medium m through a conveyance path that passes through the image former 13 and the heater 15, and eject the recording medium m to the sheet ejection tray 102.

In the case of picking up and conveying the recording medium m from the manual feed tray 101, the conveyer 12 picks up the uppermost one of the plurality of recording media m loaded on the manual feed tray 101 to load the recording medium m into the casing of the image forming apparatus 10, and conveys the recording medium m through the conveyance path. The operation from when the conveyer 12 starts conveyance of the uppermost recording medium m on the manual feed tray 101 to when the recording medium m is completely loaded into the casing is hereinafter referred to as a sheet feeding operation.

The speed at which the recording medium m picked up and conveyed by the conveyer 12 moves on the manual feed tray 101, i.e., the moving speed of the recording medium m while being loaded into the casing is determined in advance. Accordingly, the time taken from the start to the end of the sheet feeding operation (hereinafter referred to as a “sheet feeding time”) can be calculated based on the length of the recording medium m in the conveyance direction and the moving speed described above.

The conveyer 12 includes a flipper 12a that turns over the recording medium m. The flipper 12a turns over the recording medium m by loading the recording medium m into a retraction path branching from the conveyance path and thereafter feeding the recording medium m back to the conveyance path that continues ahead. With this configuration, the conveyer 12 can convey the recording medium m such that the side of the recording medium m that was facing up when on the manual feed tray 101 faces down (that is, faces the sheet ejection tray 102) when ejected to the sheet ejection tray 102. The mechanism of the flipper 12a is not limited to the mechanism described above, and any mechanism that can turn over the recording medium m may be used.

The image former 13 forms an image on the recording medium m being conveyed by the conveyer 12, using an electrophotographic system. More specifically, the image former 13 forms an electrostatic latent image by exposing the charged surface of a photoreceptor, and transfers a toner image formed by developing the electrostatic latent image to the recording medium m, thereby forming an image on the recording medium m.

The image forming system used by the image former 13 is not limited to the electrophotographic system, and may be an inkjet system that forms an image on the recording medium m by ejecting droplets of ink, for example.

The medium detector 14, which is provided for each of the manual feed tray 101 and the internal sheet feed tray 104, detects that the recording medium m is loaded on the corresponding tray, and the size of the loaded recording medium m, and outputs the detection result to the first controller 11. The medium detector 14 may be a detection device of any known type, such as an optical type and a contact type.

The heater 15 includes a pair of heater rollers each having a heating element therein. The heater 15 heats the recording medium m with an image formed thereon by nipping and conveying the recording medium m with the heating rollers, and fixes the color material such as toner applied to the recording medium m, on the recording medium m.

The heater 15 is not limited to those having heating rollers, but may be a heater that heats the recording medium m through heat emission from a position near the recording medium m.

The first communicator 16 communicates with a second communicator 23 (FIG. 3) of the imaging terminal 20 via NFC. The first communicator 16, which includes, for example, various types of communication modules and network cards, connects to the second communicator 23 via NFC of a predetermined system, and transmits/receives data according to the communication standards of the NFC. Other than exchanging various types of data with the second communicator 23, the first communicator 16 detects the start and end (disconnection) of communication connection to the second communicator 23 via NFC, and outputs the detection result to the first controller 11. The first communicator 16 is disposed in such a position that, when the imaging terminal 20 is placed on the adapter 103, the distance to the second communicator 23 of the imaging terminal 20 is within a predetermined distance (that is, within a distance range in which communication via NFC is possible). For example, the first communicator 16 is disposed inside the adapter 103.

The input-output interface 17 communicates with an external device other than the imaging terminal 20 to transmit/receive data. The input-output interface 17 performs communication according to various communication standards for wired or wireless communication, for example. Data that is received includes image data to be recorded, and data of a print job (image formation command) including settings for an image formation operation of the image data, which are input from an external device.

The operation display 18 includes a display device such as a liquid crystal display and an organic EL display, and an input device such as an operation key and a touch panel disposed on the screen of the display device. The operation display 18 displays various types of information on the display device. The operation display 18 also converts a user input on the input device into an operation signal, and outputs the operation signal to the first controller 11.

The storage 19 stores a program 191 for performing various control operations of the image forming apparatus 10. The storage 19 also stores data input from the imaging terminal 20 via the first communicator 16, and data input from an external device via the input output interface 17. The storage 19 may include, for example, a solid state drive (SSD) or a hard disk drive (HDD), and may further include a dynamic random access memory (DRAM).

The manual feed tray 101 is a plate member on which the recording medium m is loaded. The manual feed tray 101 is disposed outside the casing of the image forming apparatus 10. Accordingly, the recording medium m is loaded on the manual feed tray 101 in such a manner that one side of the recording medium m is exposed outside.

Whereas, the internal sheet feed tray 104 is a tray disposed inside the casing of the image forming apparatus 10.

Each of the manual feed tray 101 and the internal sheet feed tray 104 is configured such that a blank recording medium m is loaded thereon so as to be used for image formation by the image former 13.

When scanning the document M in the imaging system 1, the document M to be scanned is loaded on the manual feed tray 101.

The sheet ejection tray 102 is a plate member on which the recording medium m conveyed by the conveyer 12 is placed. Similar to the manual feed tray 101, the sheet ejection tray 102 is disposed outside the casing of the image forming apparatus 10. The recording medium m on which an image has been formed or that has been scanned is held on the sheet ejection tray 102 until removed the user.

The adapter 103 is a plate member attached to the casing of the image forming apparatus 10. The adapter 103 is attached over the manual feed tray 101 so as to be parallel to the manual feed tray 101. The adapter 103 has an opening 103a that is slightly smaller than the outer shape of the imaging terminal 20, according to the size of the imaging terminal 20, such that the outer peripheral end of the imaging terminal 20 is placed on the edge of the opening 103a. When the imaging terminal 20 is placed on the adapter 103, the imaging terminal 20 is positioned in the imaging position, so that the imager 22 of the imaging terminal 20 faces the manual feed tray 101 through the opening 103a, and thus can image the entire recording medium m on the manual feed tray 101.

Further, the first communicator 16 is disposed inside the adapter.

The first controller 11 is a processor that integrally controls the entire operation of the image forming apparatus 10. The first controller 11 includes a central processing unit (CPU), a random access memory (RAM), and a read only memory (ROM). The CPU performs various types of processing according to the program 191 so that the first controller 11 serves as a conveyance controller 111, a heating controller 112, a first communication controller 113, a job manager 114, an image formation controller 115, and so on.

The conveyance controller 111 performs conveyance control that causes the conveyer 12 to convey the recording medium m. That is, the conveyance controller 111 drives a motor (not illustrated) connected to the conveyance rollers 121 of the conveyer 12 to cause the conveyer 12 to pick up the recording media m from the manual feed tray 101 or the internal sheet feed tray 104 and convey the recording media m one by one through the conveyance path described above.

The heating controller 112 performs switching control of power supply to the heating element of the heater 15. That is, the heating controller 112 performs control that switches the operation (heating) of the heating element of the heater 15. The switching control may be simple ON/OFF control, or may be phased multi-level switching control. Further, PWM pulse width modulation control (PWM control) may be performed by performing high-frequency ON/OFF control.

The first communication controller 113 controls the operation (transmission/reception of data) of the first communicator 16. The content and transmission/reception timing of data transmitted/received under the control of the first communication controller 113 will be describe below.

The job manager 114 receives and manages various jobs such as a print job for image formation on the recording medium m by the image former 13 and a scan job (imaging command) for imaging of the document M by the imaging terminal 20. The print job includes a blank sheet job for outputting the recording medium m conveyed by the conveyer 12 without causing the image former 13 to form an image on the recording medium m.

The image formation controller 115 performs image formation control that causes the image former 13 to form an image on the recording medium m. That is, the image formation controller 115 operates the elements of the image former 13 according to a print job, so as to form an image of the print job on the recording medium m.

When executing a print job in the image forming apparatus 10, conveyance control by the conveyance controller 111 and image formation control by the image formation controller 115 are performed according to the content of the print job. Further, when executing a blank sheet job, image formation control is performed based on image data containing only white pixels. Accordingly, the recording medium m remaining blank is conveyed and ejected to the sheet ejection tray 102. The control performed when executing a blank sheet job is not limited to the control described above, and only the conveyance control by the conveyance controller 111 may simply be performed.

When executing a scan job in the imaging system 1, the conveyance controller 111 performs conveyance control on the document M as the subject to be conveyed, in accordance with the timing at which the imaging terminal 20 images the document M.

<Configuration of Imaging Terminal 20>

In the following, the configuration of the imaging terminal 20 will be described with reference to FIGS. 1 and 3.

FIG. 3 is a block diagram illustrating a main functional configuration of the imaging terminal 20.

The imaging terminal 20 includes a second controller 21 (second hardware processor, computer), the imager 22, the second communicator 23, an operation display 24, and a storage 25 (non-transitory computer-readable storage medium).

The imager 22 is a camera module including an optical system, such as a lens, and an imaging element. The imager 22 images a subject, and outputs the imaging data to the storage 25.

The second communicator 23 communicates with the first communicator 16 of the image forming apparatus 10 via NFC. The second communicator 23, which includes, for example, various types of communication modules, connects to the first communicator 16 via NFC of a predetermined system, and transmits/receives data according to the communication standards of the NFC. Other than exchanging various types of data with the first communicator 16, the second communicator 23 detects the start and the end (disconnection) of communication connection to the first communicator 16 via NFC, and outputs the detection result to the second controller 21.

The operation display 24 includes a display device such as a liquid crystal display and an organic EL display, and an input device such as a touch panel disposed on the screen of the display device. The operation display 24 displays various types of information on the display device, and converts a user input on the input device into an operation signal, and outputs the operation signal to the second controller 21.

The storage 25 stores a program 251 for performing various control operations of the imaging terminal 20, and the imaging data output from the imager 22. The storage 25 may be a rewritable semiconductor memory such as a flash memory.

The second controller 21 is a processor that integrally controls the entire operation of the imaging terminal 20. The second controller 21 includes a CPU, a RAM, and a ROM. The CPU performs various types of processing according to the program 251 so that the second controller 21 serves as an imaging controller 211, a second communication controller 212, an image processor 213, a storage controller 214, and so on.

The imaging controller 211 performs imaging control that causes the imager 22 to perform an imaging operation at a predetermined timing, and stores imaging data in the storage 25. Specifically, the imaging controller 211 causes the imager 22 to image the plurality of documents M loaded on the manual feed tray 101, one by one, in accordance with the timing at which the conveyer 12 conveys each of the documents M. The control of imaging timing by the imaging controller 211 will be described below.

The second communication controller 212 controls the operation (transmission/reception of data) of the second communicator 23. The content and transmission/reception timing of data transmitted/received under the control of the second communication controller 212 will be describe below.

The image processor 213 performs various types of image processing on imaging data obtained by the imager 22. The image processing performed by the image processor 213 includes resolution conversion processing of imaging data, trimming processing for removing a part of the image representing the area outside the document M according to the size of the document M, format conversion processing that converts imaging data into a predetermined format (e.g., PDF, Jpeg, Tiff, Printer Job Language (PJL), etc.).

The storage controller 214 performs an operation for storing imaging data in a predetermined storage such as the storage 25, and an operation for integrating (combining) imaging data after a long interruption of a scan job (described below).

In the following, a scanning operation of the imaging system 1 will be described. A scanning operation includes an operation for execution of a scan job of the document M, pre-processing performed before staring the scan job, and post-processing performed after the scan job.

<Overview of Scan Operation of Imaging System>

To scan the document M in the imaging system 1, the imaging terminal 20 is placed on the adapter 103 of the image forming apparatus 10. As a result, the first communicator 16 of the image forming apparatus 10 and the second communicator 23 of the imaging terminal 20 become communicable with each other via NFC, and the imaging terminal 20 is positioned in the imaging position in which the imaging terminal 20 can image the document M on the manual feed tray 101.

The plurality of documents M to be scanned are loaded on the manual feed tray 101.

Then, when a predetermined user input for starting a scan job is entered on the operation display 18 of the image forming apparatus 10, a scan job of the documents M starts.

In the scan job, an imaging operation (imaging control by the imaging controller 211) in which the imaging terminal 20 images the uppermost document M on the manual feed tray 101 and a conveyance operation (conveyance control by the conveyance controller 111) in which the image forming apparatus 10 picks up the imaged document M from the manual feed tray 101 and conveys the document M to the sheet ejection tray 102 are repeated the same number of times as the number of documents M. In this way, the plurality of documents M are automatically scanned, and the imaging data is stored in the storage 25 of the imaging terminal 20.

Also, to reliably and appropriately image the documents M, predetermined control data is exchanged between the image forming apparatus 10 and the imaging terminal 20, and imaging and conveyance of the documents M are performed in response to the control data. The control data includes an “imaging trigger” that is transmitted from the image forming apparatus 10 to the imaging terminal 20, and an “imaging completion notice” that is transmitted from the imaging terminal 20 to the image forming apparatus 10.

The imaging trigger is control data transmitted to the imaging terminal 20 in response to completion of a sheet feeding operation of the uppermost document M on the manual feed tray 101 by the conveyer 12 in the image forming apparatus 10. Upon completion of a sheet feeding operation, the next document M of the document M loaded by the sheet feeding operation becomes ready for being imaged. Then, after transmission of the imaging trigger, the imaging terminal 20 performs imaging, so that the next document M is appropriately imaged. The imaging trigger may be regarded as a signal that allows the imaging terminal 20 to image the next document M.

The imaging trigger is information used for determining the imaging timing of the document M by the imaging terminal 20 and indicating a pick-up status of the document M by the conveyer 12, and corresponds to “first information”.

The imaging completion notice is control data transmitted to the image forming apparatus 10 in response to completion of imaging of the document M by the imaging terminal 20. As long as conveyance (more specifically, sheet feeding operation) of the document M by the image forming apparatus 10 is started after completion of imaging of the document M by the imaging terminal 20, the conveyance does not affect the imaging result. Accordingly, the document M is conveyed without affecting the imaging, by allowing the image forming apparatus 10 to start conveyance of the document M after transmission of the imaging completion notice. The imaging completion notice may be regarded as a signal that allows the image forming apparatus 10 to covey the imaged document M.

The imaging completion notice is information used for determining the conveyance start timing of the document M by the image forming apparatus 10, and corresponds to “second information”.

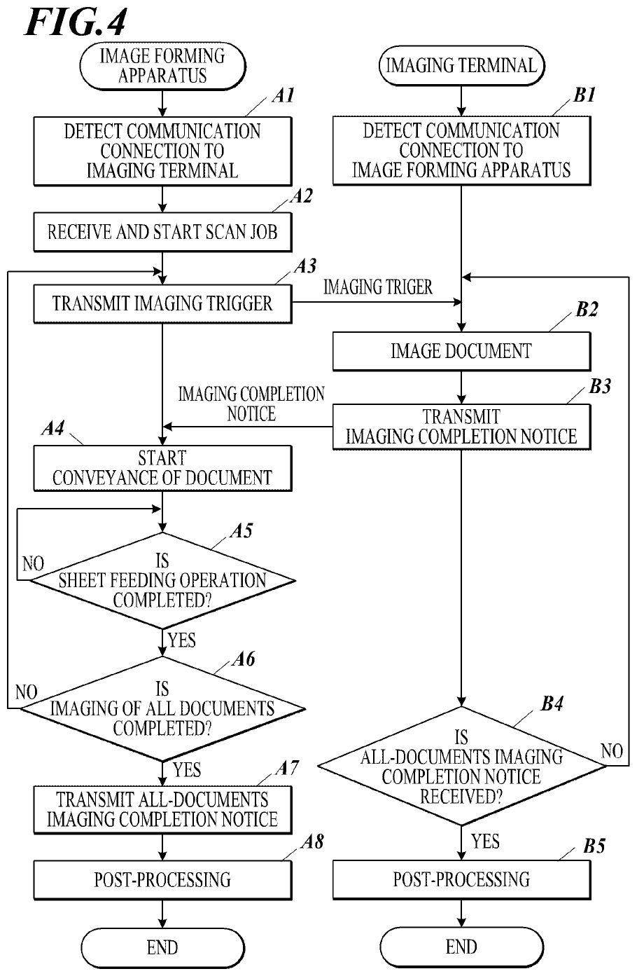

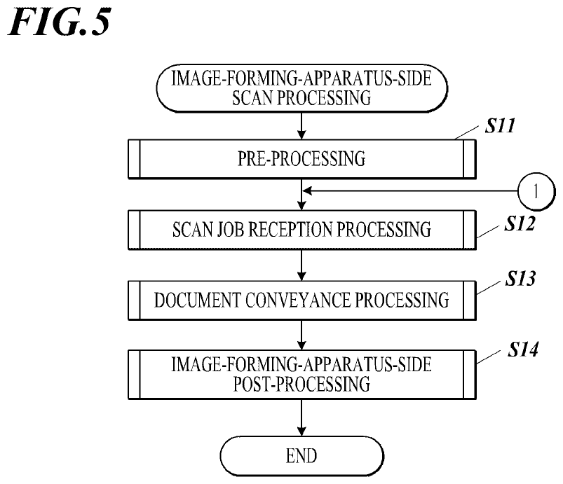

The flow of the entire scan operation including the transmission timing of the imaging trigger and the imaging completion notice will be described with reference to FIG. 4.

FIG. 4 is a flowchart illustrating the overview of a scan operation of the imaging system 1.

FIG. 4 illustrates the operation flow of each of the image forming apparatus 10 and the imaging terminal 20, and the flow of control data when the imaging system 1 performs a scan operation.

In the scan operation, when the imaging terminal 20 is placed on the adapter 103, each of the image forming apparatus 10 and the imaging terminal 20 detects a communication connection to its counterpart (step Al, step B1). Then, when a predetermined input operation is performed on the image forming apparatus 10, a scan job is received and started (step A2).

When the scan job is started, the image forming apparatus 10 transmits an imaging trigger to the imaging terminal 20 (step A3).

Having received the imaging trigger, the imaging terminal 20 images the document M (step B2), and transmits an imaging completion notice to the image forming apparatus 10 (step B3).

Having received the imaging completion notice, the image forming apparatus 10 starts conveyance of the imaged uppermost document M (step A4).

In this manner, conveyance of the document M is started after reception of the imaging completion notice from the imaging terminal 20. This prevents the document M from being conveyed before completion of imaging and hence being imaged inappropriately. Further, since conveyance of the document M can be started in response to the imaging completion notice, conveyance of the next document M can be started even when conveyance of the immediately preceding document M is not completed (that is, the immediately preceding document M has not been ejected to the sheet ejection tray 102). This can reduce the time taken to perform a scan operation.

After starting conveyance of the document M, the image forming apparatus 10 determines whether the sheet feeding operation of the document M is completed, that is, whether the above-described sheet feeding time required to completely load the document M on the manual feed tray 101 into the casing has elapsed from the start of the conveyance (step A5). Step A5 is repeated until the sheet feeding operation is completed.

If the sheet feeding operation is completed (“YES” in step A5), the image forming apparatus 10 determines whether imaging of all the documents M to be scanned is completed (step A6).

If there is a document M that has not been imaged on the manual feed tray 101 (“NO” in step A6), the process returns to step A3, and transmits an imaging trigger for the next document M to the imaging terminal 20.

In this manner, an imaging trigger is transmitted after completion of the sheet feeding operation of the document M, and the next document M is imaged after reception of the imaging trigger. This prevents the document M from being imaged inappropriately before completion of the feeding operation of the preceding document M (that is, while the preceding document M is still on the manual feed tray 101).

If, in step A6, imaging of all the documents M to be scanned is completed (“YES” in step A6), the image forming apparatus 10 transmits an all-documents imaging completion notice (imaging completion information) to the imaging terminal 20 (step A7). The all-documents imaging completion notice is one of the control data described above.

After that, the image forming apparatus 10 performs predetermined post-processing (step A8).

Until the all-documents imaging completion notice is received (“NO” in step B4), the imaging terminal 20 repeats imaging of the document M in response to reception of an imaging trigger. Upon receiving the all-documents imaging completion notice (“YES” in step B4), the imaging terminal 20 performs predetermined post-processing (step B5).

Upon completion of the post-processing in step A8 and step B5, the scanning operation ends.

Hereinafter, other characteristics of the scan operation will be described.

<Pre-processing 1: Processing of Print Job Being Executed>

If the image forming apparatus 10 is executing a print job when the imaging terminal 20 is connected for scanning the document M, a scan job is normally started after completion of the print job.

However, if the sheet specified (recording medium m) for the print job being executed is the sheet on the manual feed tray 101 and if the manual feed tray 101 is empty (that is, if there are no sheets on the manual feed tray 101 and the user is requested to supply a sheet to the manual feed tray 101), the print job is interrupted. This is because, if the document M to be printed is loaded on the manual feed tray 101 without interrupting the print job, the document M is regarded as a sheet supplied to the manual feed tray 101 for the print job, and an image for the print job is formed on the document M.

The scan job may be started by immediately interrupting the print job being executed, regardless of which sheet is specified.

In the case where a print job is received via the input-output interface 17 after a scan job is started, execution of the print job is put on hold until the scan job is completed.

The interrupted or pending print job is executed after completion of the scan job.

<Pre-processing 2: Control of Heater>

Since a scan job does not involve image formation by the image former 13, there is no need to heat the document M for fixing an image with the heater 15. If the scanned document M is heated on the conveyance path by the heater 15, the document M may be damaged

Therefore, in the scan operation in the imaging system 1, the operation of the heater 15 is controlled such that the heating temperature of the document M by the heater 15 satisfies a predetermined low temperature condition in advance, before starting a scan job. Typically, power supply to the heater 15 is stopped so as to stop the heating operation of the heater 15. Examples of the predetermined low temperature condition may include a condition that the temperature of the heater 15 is lower than or equal to a predetermined reference temperature. The reference temperature may be determined according to the type of the recording medium m used as the document M, and the properties of the color material.

<Short Interruption Control of Scan Job>

There is a case where a smartphone serving as the imaging terminal 20 is detached from the adapter 103 by the user during execution of a scan job. For example, this may be a case where the user receives a call on his smartphone and needs to answer the call. It should be noted that, to easily respond to this situation, the imaging terminal 20 may transmit, in response to an incoming call to the smartphone (imaging terminal 20), a notice of the incoming call to the image forming apparatus 10, and the image forming apparatus 10 may display an indication of the incoming call on the operation display 18 in response to reception of the notice.

If the imaging terminal 20 is detached from the adapter 103, the communication between the image forming apparatus 10 and the imaging terminal 20 via NFC is disconnected. In this case, each of the image forming apparatus 10 and the imaging terminal 20 detects the disconnection of the communication, and performs processing for stopping the subsequent operation of the scan job.

Each of the image forming apparatus 10 and the imaging terminal 20 may be configured not to perform any particular processing for stopping a scan job. While the communication with the image forming apparatus 10 and the imaging terminal 20 is disconnected, even if an imaging trigger is transmitted from the image forming apparatus 10, the imaging trigger is not received by the imaging terminal 20, so that the subsequent imaging is automatically interrupted. Also, even if an imaging completion notice is transmitted to the imaging terminal 20, the imaging completion notice is not received by the image forming apparatus 10, so that the subsequent conveyance of the document M is automatically interrupted. In this manner, since imaging and conveyance are started in response to an imaging trigger and an imaging completion notice, respectively, it is possible to easily and reliably interrupt a scan job when the imaging terminal 20 is detached.

When the imaging terminal 20 is reconnected to the image forming apparatus 10 during interruption of a scan operation, the scan job is resumed from the document M that was being scanned at the time of the interruption.

<Long Interruption Control of Scan Job>

When an interruption of a scan job satisfies a predetermined long interruption condition, long interruption control is performed. Examples of the long interruption condition may include a condition that an interruption of a scan job lasts for a reference period of time or longer. This reference period of time can be appropriately determined according to the usage of the imaging system 1, and may be in the range from about 10 minutes to 30 minutes, for example. Examples of the long interruption condition may also include a condition that a user input indicating a long interruption is entered on the operation display 18.

When long interruption control is enabled, the image forming apparatus 10 starts the heating operation of the heater 15, and receives another print job. The print job received in this case is one specifying a sheet on the internal sheet feed tray 104. This is because if a print job specifying a sheet on the manual feed tray 101 is received, an image is formed on the document M waiting to be scanned on the manual feed tray 101. However, if removal of sheets from the manual feed tray 101 is detected after starting long interruption control, a print job specifying a sheet on the manual feed tray 101 may be received from then on.

In response to starting of long interruption control, the imaging terminal 20 stores imaging data obtained before the interruption as interrupted imaging data in the storage 25.

If the imaging terminal 20 is reconnected to the image forming apparatus 10 after the long interruption control is started, the image forming apparatus 10 interrupts a print job being executed, stops the heating operation of the heater 15, and resumes the scan job when the temperature of the heater 15 falls to or below the reference temperature.

The imaging terminal 20 integrates the interrupted imaging data and the imaging data obtained after the resumption of the scan operation.

<Image Processing>

In a scan operation, the medium detector 14 detects the size of the document M loaded on the manual feed tray 101, and the image processor 213 of the imaging terminal 20 resizes the obtained image according to the detected size of the document M. Accordingly, in the case where the captured image contains an image of the area outside the document M (usually, the surface of the manual feed tray 101), the captured image is trimmed to include only the image of the document M, so that an appropriate scan image is obtained.

The size of the document M does not have to be detected by the medium detector 14, and may be detected based on the imaging result obtained by the imaging terminal 20, using any contour detection technique, for example. Alternatively, the size of the document M may be specified by a user input on the operation display 18.

<Storage Control>

In a scan operation, imaging data is usually stored in the storage 25 of the imaging terminal 20. However, imaging data may be stored in a storage other than the storage 25, in the case where the memory space of the storage 25 is small, or based on the storage settings specified in advance by the user. Examples of the storage other than the storage 25 may include the storage 19 of the image forming apparatus 10, and other external devices connected to the image forming apparatus 10 or the imaging terminal 20 (a storage installed in a personal computer, an online storage, a storage in an another camera terminal, etc.).

The following individually describes image-forming-apparatus-side scan processing by the first controller 11, and imaging-terminal-side scan processing by the second controller 21, as the processing for executing the scan operation in the imaging system 1.

<Image-Forming-Apparatus-Side Scan Processing>

FIG. 5 is a flowchart illustrating the control steps of image-forming-apparatus-side scan processing by the first controller 11.

In image-forming-apparatus-side scan processing, the first controller 11 sequentially executes pre-processing S11, scan job reception processing S12, document conveyance processing S13, and image-forming-apparatus-side post-processing S14.

At least part of the program for executing the image-forming-apparatus-side scan processing in the image forming apparatus 10 may be a program that can be installed after shipment, such as an application program that runs on an Internal Web Server (IWS) provided in the image forming apparatus 10. Accordingly, even if the image forming apparatus 10 does not support the scan operation of this embodiment at the time of shipment, the image forming apparatus 10 becomes able to support the scan operation by installing the above application program.

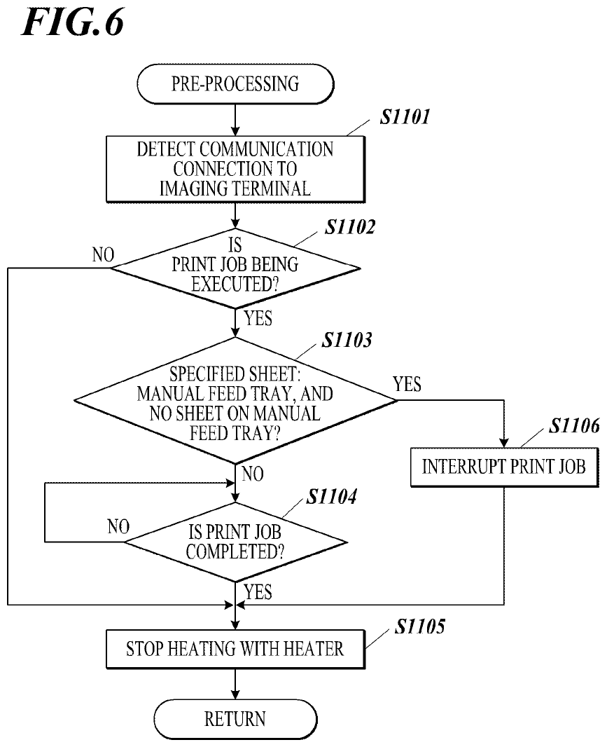

FIG. 6 is a flowchart illustrating the control steps of pre-processing by the first controller 11.

When pre-processing starts, the first controller 11 detects a communication connection to the imaging terminal 20, based on a detection signal from the first communicator 16 (step S1101).

The first controller 11 (job manager 114) determines whether a print job is being executed (step S1102). If a print job is being executed (“YES” in step S1102), the first controller 11 (job manager 114) determines whether a sheet on the manual feed tray 101 is specified for the print job being executed and there is no sheet on the manual feed tray 101 (step S1103). If a sheet on the manual feed tray 101 is specified for the print job being executed and if there is no sheet on the manual feed tray 101 (“YES” in step S1103), the first controller 11 interrupts the print job (step S1106).

If a sheet on the manual feed tray 101 is not specified for the print job being executed, or if there is a sheet on the manual feed tray 101 (“NO” in step S1103), the first controller 11 (job manager 114) continues the print job until the print job is completed (step S1104).

If no print job is being executed in step S1102 (“NO” in step S1102), if the print job is completed in step S1104 (“YES” in step S1104), or if step S1106 is started, the first controller 11 (heating controller 112) stops the heating operation of the heater 15 (step S1105). Then, the process returns to the image-forming-apparatus-side scan processing to start scan job reception processing in S12.

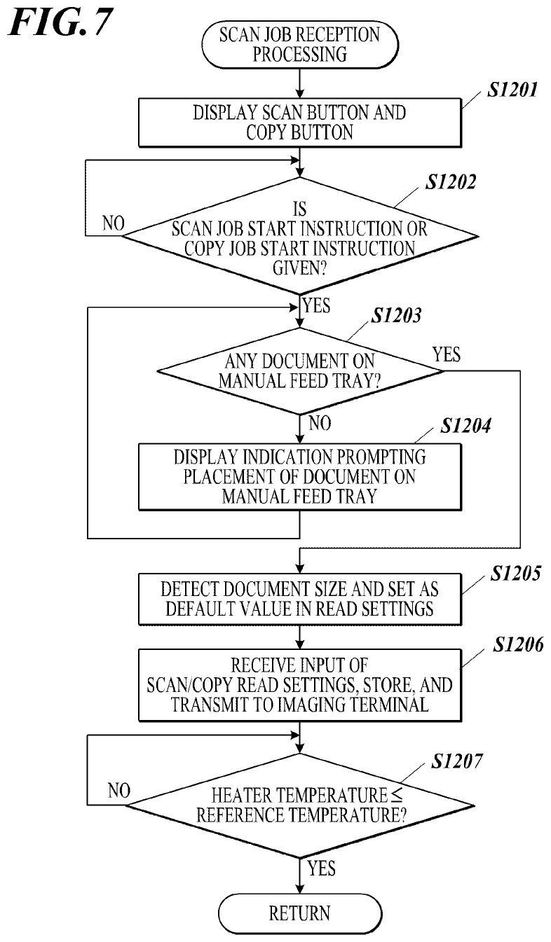

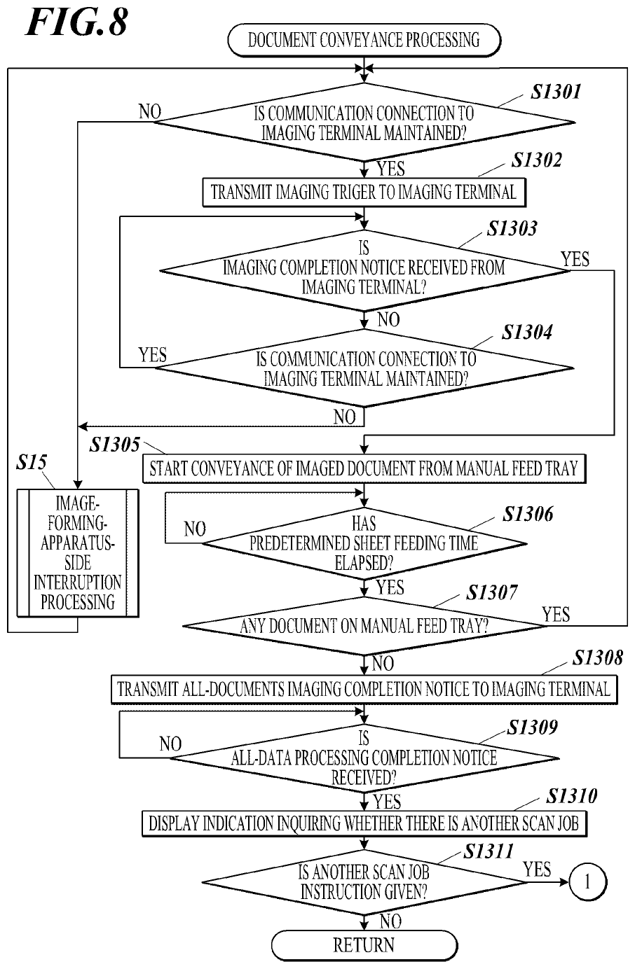

FIG. 7 is a flowchart illustrating the control steps of scan job reception processing by the first controller 11.

When scan job reception processing starts, the first controller 11 (job manager 114) causes the operation display 18 to display a scan button for starting a scan job, and a copy button for staring a copy job (step S1201).

The first controller 11 (job manager 114) determines whether a start instruction of a scan job is given by the user by operating the scan button, or a start instruction of a copy job is given by the user by operating the copy button (step S1202). If neither of the start instructions is given (“NO” in step S1202), the first controller 11 (job manager 114) performs step S1202 again.

If either of the start instructions of a scan job and a copy job is given (“YES” in step S1202), the first controller 11 (job manager 114) determines whether the document M is loaded on the manual feed tray 101 based on a detection signal from the medium detector 14 (step S1203). If the document M is not loaded on the manual feed tray (“NO” in step S1203), the first controller 11 (job manager 114) causes the operation display 18 to display a predetermined indication that prompts the user to place the document M on the manual feed tray 101 (step S1204). Then, the process returns to step S1203.

If the document M is loaded on the manual feed tray 101 (“YES” in step S1203), the first controller 11 (job manager 114) detects the size of the document M based on a detection signal from the medium detector 14, and sets the detected size as the default value of the document M in the scan settings or the copy settings (step S1205).

The first controller 11 (job manager 114, first communication controller 113) causes the operation display 18 to display a predetermined input screen for inputting the scan settings or the copy settings, receives an input of the scan settings or the copy settings, and stores the input and determined scan settings or the copy settings in the storage 19, and causes the first communicator 16 to transmit the scan settings or the copy settings to the imaging terminal 20.

The scan settings include the size of the document M, the resolution and the format (PDF, Jpeg, Tiff, etc.) of imaging data to be generated, and the storage in which the imaging data is to be stored (the storage 25 of the imaging terminal 20, the storage 19 of the image forming apparatus 10, a cloud storage, e-mail transmission, file transfer protocol (FTP) transfer, Server Message Block (SMB) transfer, etc.). The copy settings include the number of copies, duplex printing settings, and layout settings, in addition to the scan settings described above.

Of these, in the size settings of the document M, the size detected in step S1205 is set as the default. If the user wants to change the settings of the size of the document M, or if the size of the document M cannot be detected in step S1205, the size is set in step S1206.

The first controller 11 (heating controller 112) determines whether the temperature of the heater 15 is lower than or equal to the reference temperature (step S1207). If the temperature of the heater 15 is not lower than or equal to the reference temperature (“NO” in step S1207), the first controller 11 (heating controller 112) performs step S1207 again. If the temperature of the heater 15 is lower than or equal to the reference temperature (“YES” in step S1207), the process returns to the image-forming-apparatus-side scan processing to start the document conveyance processing in S13.

FIG. 8 is a flowchart illustrating the control steps of document conveyance processing by the first controller 11.

When document conveyance processing starts, the first controller 11 determines whether the communication connection to the imaging terminal 20 is maintained (step S1301). If the communication is disconnected (“NO” in step S1301), the first controller 11 starts image-forming-apparatus-side interruption processing (described below) (step S15).

If the communication connection to the imaging terminal 20 is maintained (“YES” in step S1301), the first controller 11 (first communication controller 113) causes the first communicator 16 to transmit an imaging trigger to the imaging terminal 20 (step S1302).

The first controller 11 determines whether an imaging completion notice is received from the imaging terminal 20 (step S1303). If an imaging completion notice is not received (“NO” in step S1303), the first controller 11 determines whether the communication connection to the imaging terminal 20 is maintained (step S1304). If the communication is disconnected (“NO” in step S1304), the first controller 11 starts image-forming-apparatus-side interruption processing (step S15). If the communication connection is maintained (“YES” in step S1304), the process returns to step S1303.

If an imaging completion notice is received in step S1303 (“YES” in step S1303), the first controller 11 (conveyance controller 111) activates the conveyer 12 to start conveyance of the imaged document M (the uppermost document Mon the manual feed tray 101) (step S1305).

The first controller 11 (conveyance controller 111) determines whether a predetermined sheet feeding time has elapsed from the start of the conveyance (step S1306). If the predetermined sheet feeding time has not elapsed (“NO” in step S1306), the first controller 11 (conveyance controller 111) performs step S1306 again.

If the sheet feeding time has elapsed (that is, a sheet feeding operation is completed and the document M is completely loaded from the manual feed tray 101 into the casing) (“YES” in step S1306), the first controller 11 determines whether there is any other document M on the manual feed tray 101 (that is, whether there is a document M yet to be imaged), based on a detection signal from the medium detector 14 (step S1307). If there is any other document M (“YES” in step S1307), the process returns to step S1301.

If there is no other document Mon the manual feed tray 101 (“NO” in step S1307), the first controller 11 (first communication controller 113) causes the first communicator 16 to transmit an all-documents imaging completion notice to the imaging terminal 20 (step S1308).

The first controller 11 determines whether an all-data processing completion notice is received from the imaging terminal 20 (step S1309). If an all-data processing completion notice is not received (“NO” in step S1309), the first controller 11 performs step S1309 again. If an all-data processing completion notice is received (“YES” in step S1309), the first controller 11 causes the operation display 18 to display a predetermined indication that inquires whether there is another scan job (step S1310). The first controller 11 determines whether a user input indicating that there is another scan job is entered on the operation display 18 (step S1311). If a user input indicating that there is another scan job is entered (“YES” in step S1311), the first controller 11 starts the scan job reception processing in S12 of FIG. 5. If a user input indicating that there is no other scan job is entered (“NO” in step S1311), the process returns to the image-forming-apparatus-side scan processing to start the image-forming-apparatus-side post-processing in S14.

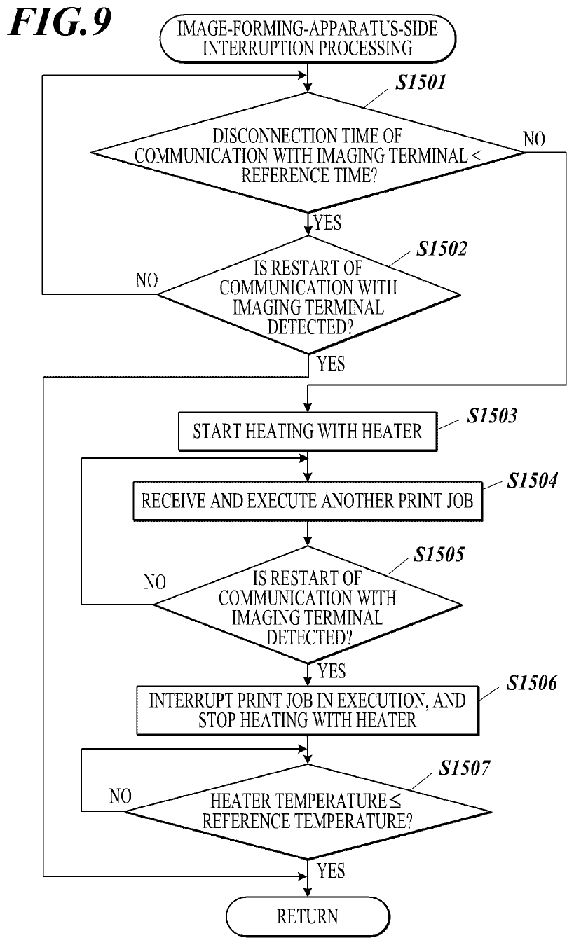

FIG. 9 is a flowchart illustrating the control steps of image-forming-apparatus-side interruption processing by the first controller 11.

When image-forming-apparatus-side interruption processing starts, the first controller 11 determines whether a disconnection time of communication with the imaging terminal 20 is less than the reference time described above (step S1501). If the communication disconnection time is less than the reference time (“YES” in step S1501), the first controller 11 detects whether communication with the imaging terminal 20 is restarted (step S1502). If communication with the imaging terminal 20 is not restarted (“NO” in step S1502), the process returns to step S1501. If communication with the imaging terminal 20 is restarted (“YES” in step S1502), the first controller 11 ends the image-forming-apparatus-side interruption processing, and the process returns to step S1301 of the document conveyance processing.

If the communication disconnection time is greater than or equal to the reference time in step S1501 (“NO” in step S1501), the first controller 11 (heating controller 112) starts the heating operation of the heater 15 (step S1503). Then, if the temperature of the heater 15 becomes equal to or higher than the reference temperature, the first controller 11 (job manager 114) receives and executes another print job (step S1504). However, as mentioned above, until removal of the document M from the manual feed tray 101 is detected, the first controller 11 (job manager 114) receives only a print job specifying a sheet on the internal sheet feed tray 104.

The first controller 11 detects whether communication with the imaging terminal 20 is restarted (step S1505). If communication with the imaging terminal 20 is not restarted (“NO” in step S1505), the process returns to step S1504. If communication with the imaging terminal 20 is restarted (“YES” in step S1505), the first controller 11 (heating controller 112, job manager 114) interrupts the print job being executed, and stops the heating operation of the heater 15 (step S1506).

The first controller 11 (heating controller 112) determines whether the temperature of the heater 15 is lower than or equal to the reference temperature of the heater 15 (step S1507). If the temperature of the heater 15 is not lower than or equal to the reference temperature (“NO” in step S1507), the first controller 11 (heating controller 112) performs step S1507 again. If the temperature of the heater 15 is lower than or equal to the reference temperature (“YES” in step S1507), the first controller 11 ends the image-forming-apparatus-side interruption processing, and the process returns to step S1301 of the document conveyance processing.

It should be noted that when restart of communication connection to the imaging terminal 20 is detected in step S1502 or S1505, an indication that queries the user whether to resume the scan job may be displayed on the operation display 18, and the scan job may be resumed if resumption is indicated.

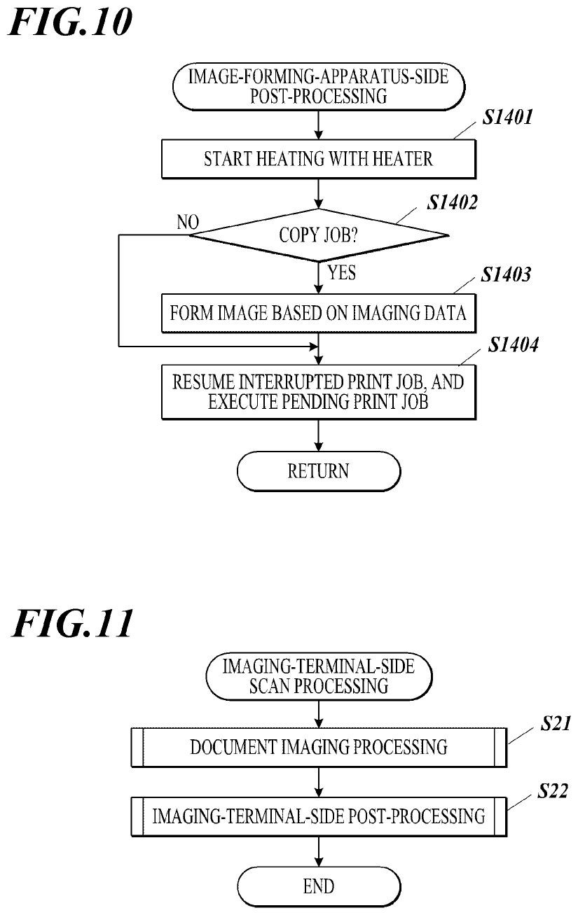

FIG. 10 is a flowchart illustrating the control steps of image-forming-apparatus-side post-processing by the first controller 11.

When image-forming-apparatus-side post-processing starts, the first controller 11 (heating controller 112) starts the heating operation of the heater 15 (step S1401).

If the job being executed is a copy job (“YES” in step S1402), the first controller 11 (image formation controller 115, job manager 114) causes the image former 13 to form an image on a blank recording medium m, based on the imaging data of the document M received from the imaging terminal 20 (step S1403).

If the job being executed is a scan job (“NO” in step S1402), or if step S1403 ends, the first controller 11 (job manager 114) resumes an interrupted print job if any, and executes a print job yet to be started if any (step S1404).

After step S1404 is finished, the first controller 11 ends the image-forming-apparatus-side post-processing and the image-forming-apparatus-side scan processing.

<Imaging-Terminal-Side Scan Processing>

FIG. 11 is a flowchart illustrating the control steps of imaging-terminal-side scan processing by the second controller 21.

In imaging-terminal-side scan processing, the second controller 21 sequentially executes document imaging processing S21, and imaging-terminal-side post-processing S22.

At least part of the program for executing the imaging-terminal-side scan processing in the imaging terminal 20 may be a program that can be installed and run on the imaging terminal 20. Accordingly, even if the imaging terminal 20 does not support the scan operation of this embodiment at the time of shipment, the imaging terminal 20 becomes able to support the scan operation by installing the above application program.

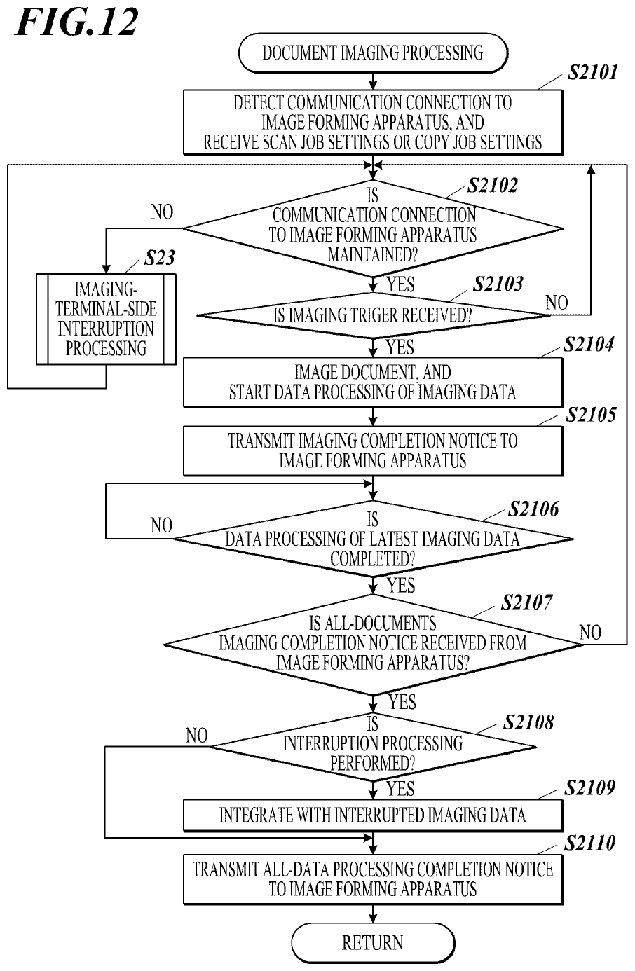

FIG. 12 is a flowchart illustrating the control steps of document imaging processing by the second controller 21.

When document imaging processing starts, the second controller 21 detects a communication connection to the image forming apparatus 10, based on a detection signal from the second communicator 23, and receives scan job settings or copy job settings (step S2101).

The second controller 21 determines whether the communication connection to the image forming apparatus 10 is maintained (step S2102). If the communication is disconnected (“NO” in step S2102), the second controller 21 starts imaging-terminal-side interruption processing (described below) (step S23).

If the communication connection to the image forming apparatus 10 is maintained (“YES” in step S2102), the second controller 21 determines whether an imaging trigger is received from the image forming apparatus 10 (step S2103). If an imaging trigger is not received (“NO” in step S2103), the process returns to step S2102.

If an imaging trigger is received from the image forming apparatus 10 (“YES” in step S2103), the second controller 21 (imaging controller 211, image processor 213) causes the imager 22 to image the document M, and starts data processing of the imaging data (step S2104).

In this step, the second controller 21 causes the imager 22 to image the document Mat a resolution greater than the resolution specified in the scan job settings.

The second controller 21 performs, as data processing of the imaging data, trimming processing, and resolution conversion processing to the resolution specified in the scan job settings. In trimming processing, the contour of the document area in the captured image is detected, and trimming is performed based on the detected contour area, as needed. Further, if the contour area is trapezoidal, the contour area is resized through affine transformation or the like so as to match the specified size of the document M.

After completion of imaging of the document M in step S2104, the second controller 21 (second communication controller 212) causes the second communicator 23 to transmit an imaging completion notice to the image forming apparatus 10 (step S2105).

Step S2105 does not have to be started after completion of data processing of the imaging data started in step S2104, and is usually executed in parallel with data processing.

The second controller 21 determines whether the data processing of the latest imaging data started in step S2104 is completed (step S2106). If the data processing is not completed (“NO” in step S2106), the second controller 21 performs step S2106 again. If the data processing is completed (“YES” in step S2106), the second controller 21 determines whether an all-document imaging completion notice is received from the image forming apparatus 10 (step S2107). If an all-document imaging completion notice is not received (“NO” in step S2107), the process returns to step S2102.

If an all-document processing completion notice is received (“YES” in step S2107), the second controller 21 determines whether interruption processing has been performed once or more times during execution of the current scan job or copy job (step S2108). If interruption processing has been performed (“YES” in step S2108), the second controller 21 (storage controller 214) integrates interrupted imaging data stored in the storage 25 and imaging data obtained after the resumption (step S2109).

If interruption processing has not been performed (“NO” in step S2108), or if step S2109 is finished, the second controller 21 (second communication controller 212) causes the second communicator 23 to transmit an all-data processing completion notice to the image forming apparatus 10 (step S2110).

After step S2110 is finished, the second controller 21 ends the document imaging processing. Then, the process returns to the imaging-terminal-side scan processing to start imaging-terminal-side post-processing in S22.

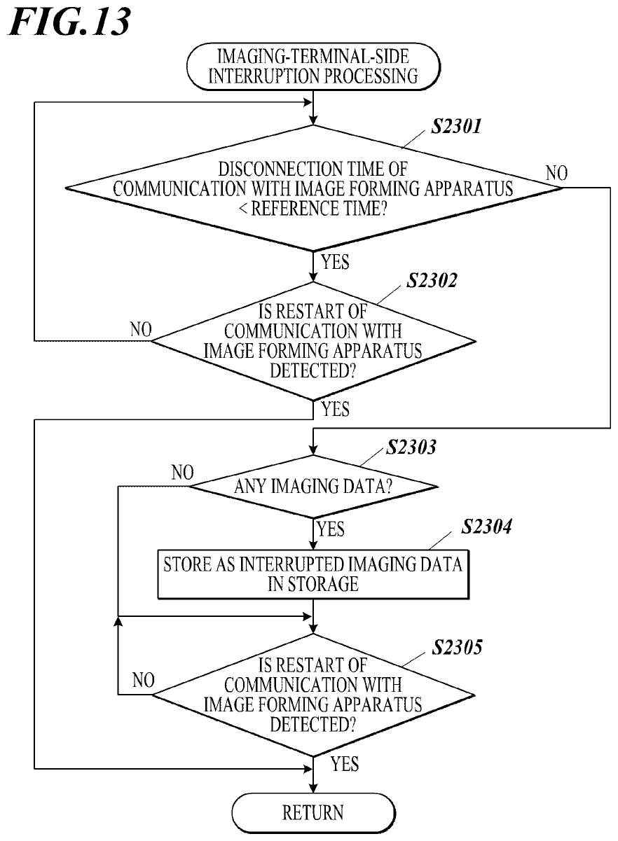

FIG. 13 is a flowchart illustrating the control steps of imaging-terminal-side interruption processing by the second controller 21.

When imaging-terminal-side interruption processing starts, the second controller 21 determines whether a disconnection time of communication with the image forming apparatus 10 is less than the reference time described above (step S2301). If the communication disconnection time is less than the reference time (“YES” in step S2301), the second controller 21 determines whether communication with the image forming apparatus 10 is restarted (step S2302). If communication with the image forming apparatus 10 is not restarted (“NO” in step S2302), the process returns to step S2301. If communication with the image forming apparatus 10 is restarted (“YES” in step S2302), the second controller 21 ends the imaging-terminal-side interruption processing, and the process returns to step S2102 of the document imaging processing.

If the communication disconnection time is greater than or equal to the reference time in step S2301 (“NO” in step S2301), the second controller 21 (storage controller 214) determines whether there is imaging data captured in the current scan job (step S2303). If there is imaging data (“YES” in step S2303), the second controller 21 (storage controller 214) stores the imaging data as interrupted imaging data in the storage 25 (step S2304).

If there is no imaging data in step S2303 (“NO” in step S2303), or if step S2304 is finished, the second controller 21 detects whether communication with the image forming apparatus 10 is restarted (step S2305). If communication with the image forming apparatus 10 is not restarted (“NO” in step S2305), the second controller 21 performs step S2305 again. If communication with the image forming apparatus 10 is restarted (“YES” in step S2305), the second controller 21 ends the imaging-terminal-side interruption processing, and the process returns to step S2102 of the document imaging processing.

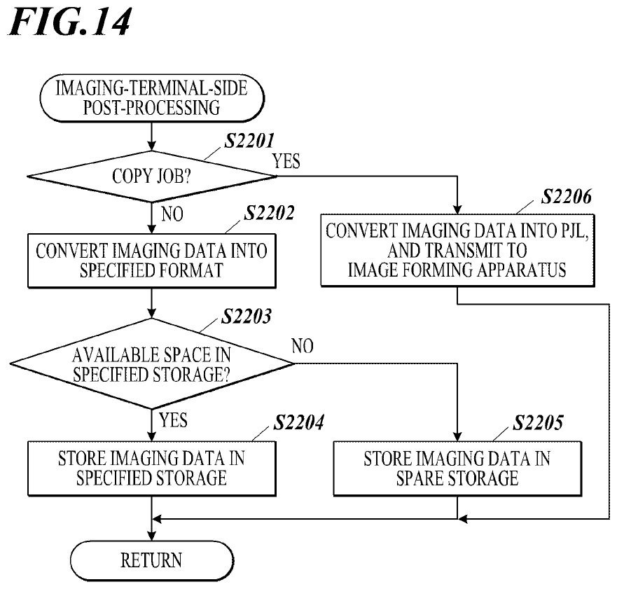

FIG. 14 is a flowchart illustrating the control steps of imaging-terminal-side post-processing by the second controller 21.

When imaging-terminal-side post-processing starts, if the job being executed is not a copy job (the job is a scan job) (“NO” in step S2201), the second controller 21 (image processor 213) converts the imaging data into a format specified in the scan job settings (step S2202). Then, the second controller 21 (storage controller 214) determines whether the storage (for example, storage 25) specified in the scan job settings has enough available space to store the imaging data (step S2203). If there is enough available space (“YES” in step S2203), the second controller 21 (storage controller 214) stores the imaging data in the specified storage 25 (step S2204). If there is not enough available space (“NO” in step S2203), the second controller 21 (storage controller 214) stores the imaging data in a predetermined spare storage (step S2205).

If the job being executed is a copy job in step S2201 (“YES” in step S2201), the second controller 21 (second communication controller 212, image processor 213) converts imaging data into PJL data, and causes the second communicator 23 to transmit the PJL data to the image forming apparatus 10 (step S2206). Conversion into PJL data and transmission to the image forming apparatus 10 may be performed every time a document M is imaged.

After step S2204, step S2205, or step S2206 is finished, the second controller 21 ends the imaging terminal-side post-processing and the imaging-terminal-side scan processing.

As described above, the imaging system 1 according to the present embodiment includes: the image forming apparatus 10 including the conveyer 12 that conveys the recording medium m, the manual feed tray 101 on which the recording medium m to be fed to the conveyer 12 is loaded while being exposed outside, the first controller 11 that causes the conveyer 12 to convey plural of the recording media m loaded on the manual feed tray 101 one by one, the image former 13 that forms an image on the recording medium m being conveyed by the conveyer 12, and the first communicator 16; and the imaging terminal 20 including the imager 22, the second controller 21 that causes the imager 22 to image a plurality of documents M one by one in accordance with the timing at which the conveyer 12 conveys each of the documents M, the plurality of documents M being the plurality of recording media m loaded on the manual feed tray 101 to be imaged, and the second communicator 23 that communicates with the first communicator 16; wherein, when the imaging terminal 20 images the plurality of documents M, at least one of following is performed: transmission of an imaging trigger as first information used for determining an imaging timing of the document M by the second controller 21 (imaging controller 211), from the first communicator 16 to the second communicator 23; and transmission of an imaging completion notice as second information used for determining a conveyance start timing of the document M by the first controller 11 (conveyance controller 111), from the second communicator 23 to the first communicator 16.

With this configuration, an imaging operation by the imaging terminal 20 to image the uppermost document M on the manual feed tray 101 and a conveyance operation by the image forming apparatus 10 to pick up the imaged document M from the manual feed tray 101 and convey the document M to the sheet ejection tray 102 are repeated the same number of times as the number of documents M. Accordingly, it is possible to automatically scan the plurality of documents M without requiring the user to feed the documents M one by one.

Moreover, the imaging terminal 20 performs imaging in response to the imaging trigger transmitted from the image forming apparatus 10. Accordingly, it is possible to prevent the document M from being imaged inappropriately while the sheet feeding operation of the immediately preceding document M is not completed (that is, while the preceding document M is still on the manual feed tray 101).

Furthermore, conveyance of the document M by the image forming apparatus 10 is started in response to the completion notice transmitted from the imaging terminal 20. Accordingly, it is possible to prevent the document M from being conveyed before completion of imaging and hence being imaged inappropriately.

As a result, the document M can be appropriately imaged more easily.

Furthermore, since the document M on the manual feed tray 101 is imaged, a scan job can be interrupted at any time. According to a related-art method that images the document M on the sheet ejection tray 102, if a scan job is interrupted while the document Mon the sheet ejection tray 102 is not yet imaged and the next document M is being conveyed, the next document M is ejected over the document M yet to be imaged. Therefore, to resume the scan job, the document M ejected over the document M yet to be imaged needs to be removed. In contrast, in the present embodiment, the document Mon the manual feed tray 101 is imaged. Accordingly, even if a scan job is interrupted at an arbitrary time such as during conveyance of the document M, the scan job can be resumed without requiring extra work.

Furthermore, according to the related-art method that images the document M on the sheet ejection tray 102, the document M may become dirty by being creased, getting marks of the conveyance rollers, or being smeared with toner or ink, or get damaged by heat during conveyance. Such dirtiness and damage may appear in the captured image of the document. In contrast, in the present embodiment, the document M on the manual feed tray 101 is imaged before conveyance, and then is conveyed. Accordingly, even if the document M becomes dirty or damaged during conveyance, this does not affect the imaging data. Accordingly, it is possible to prevent a reduction in quality of the imaging data.

Further, the first controller 11 (first communication controller 113) is configured to cause the first communicator 16 to transmit the imaging trigger to the second communicator 23, in accordance with the timing at which the conveyer 12 picks up the document M from the manual feed tray 101, and the second controller 21 (imaging controller 211) is configured to cause the imager 22 to image the next document M of the document M picked up by the conveyer 12, in response to the imaging trigger. Accordingly, it is possible to prevent the document M from being imaged inappropriately before completion of the sheet feeding operation of the immediately preceding document M.

Further, the second controller 21 (second communication controller 212) is configured to cause the second communicator 23 to transmit the imaging completion notice to the first communicator 16, in response to completion of imaging of the document M by the imager 22, and the first controller 11 (conveyance controller 111) is configured to cause the conveyer 12 to pick up and convey the document M imaged by the imager 22, in response to the imaging completion notice. Accordingly, it is possible to prevent the document M from being conveyed before completion of imaging and hence being imaged inappropriately.

Further, the first controller 11 (first communication controller 113) is configured to, when all the documents M are picked up from the manual feed tray 101 by the conveyer 12, cause the first communicator 16 to transmit an all-documents imaging completion notice to the second communicator 23. Accordingly, it is possible to detect completion of imaging of all the documents in a simple way.

Further, the image forming apparatus 10 further includes the sheet ejection tray 102 on which the document M conveyed by the conveyer 12 is placed, and the first controller 11 (conveyance controller 111) is configured to cause the conveyer 12 to convey the document M such that the side of the document M imaged on the manual feed tray 101 by the imager 22 faces the sheet ejection tray 102 when the document M is on the sheet ejection tray 102. With this configuration, it is possible to scan the documents M while keeping the order of the documents M. According to the related-art method that images the document M on the sheet ejection tray 102, the documents M need to be stacked on the sheet ejection tray 102 such that the side of each document M that is imaged faces up on the sheet ejection tray 102. Therefore, the documents M on the sheet ejection tray 102 are stacked in the reverse order of the order of the documents M on the manual feed tray 101. In contrast, in the present embodiment, the document M is imaged on the manual feed tray 101. Accordingly, it is possible to stack the documents M such that the side of each document M that is imaged faces down on the sheet ejection tray 102, and hence to scan the documents M while keeping the order of the documents M.

Further, the first controller 11 (conveyance controller 111) is configured to, before the document M being conveyed by the conveyer 12 is placed on the sheet ejection tray 102, cause the conveyer 12 to start conveyance of the next document M. This can reduce the time taken to perform a scan operation.

Further, the first controller 11 (conveyance controller 111) is configured to stop conveyance of the next document M by the conveyer 12, in response to detection of a disconnection of communication between the first communicator 16 and the second communicator 23. Accordingly, it is possible to keep the document M that is yet to be imaged on the manual feed tray 101, and hence to resume the scan job easily.

Further, the image forming apparatus 10 further includes the heater 15 that heats the document M to fix the image formed on the document M, and the first controller 11 is configured to, when the imaging terminal 20 images the plurality of documents M, control the operation of the heater 15 such that the heating temperature of the document M by the heater 15 satisfies a predetermined low temperature condition (heating controller 112), and after the heating temperature of the document M by the heater 15 satisfies the low temperature condition, cause the conveyer 12 to pick up and convey the document M imaged by the imager 22 (conveyance controller 111). Accordingly, it is possible to prevent the document M from being damaged by the heat of the heater 15. Moreover, it is possible to prevent a reduction in quality of imaging data due to damage to the document M.

Further, the first controller 11 (heating controller 112) is configured to stop the heating operation of the heater 15 when the imaging terminal 20 images the document M. Accordingly, it is possible to more reliably prevent the document M from being damaged by the heat of the heater 15.

Further, the first controller 11 (heating controller 112) is configured to, when a scan job for imaging the document M by the imaging terminal 20 is interrupted and the interruption satisfies a predetermined long interruption condition, restart the heating operation of the heater 15. This makes it possible to receive and execute a print job while a scan job is interrupted, so that the image forming apparatus 10 can efficiently execute the print job and the scan job.

Further, the first controller 11 (job manager 114) is configured to receive and manage a scan job and a print job, and the second controller 21 (storage controller 214) is configured to, when the first controller 11 (job manager 114) detects an interruption of the scan job, store imaging data already captured in the predetermined storage 25, and when the first controller 11 (job manager 114) detects resumption of the scan job, integrate the imaging data stored in the storage 25 and image data captured after the resumption of the scan job. With this configuration, even when there is an interruption of a scan job, it is possible to obtain the same imaging data as that obtained when there is no interruption.

Further, the first controller 11 is configured to, if the first controller 11 (job manager 114) detects an interruption of the scan job and if the interruption satisfies a predetermined long interruption condition, receive the print job with respect to the recording medium m that is fed through a path not passing through the manual feed tray 101. This makes it possible to receive and execute a print job while a scan job is interrupted, so that the image forming apparatus 10 can efficiently execute the print job and the scan job.

Further, the first controller 11 (job manager 114) is configured to, after communication between the first communicator 16 and the second communicator 23 is started, if there is an uncompleted print job with respect to the recording medium m fed from the manual feed tray 101 and if no recording medium m is detected on the manual feed tray 101, interrupt the print job until the scan job is completed. Accordingly, when the document M to be scanned is loaded on the manual feed tray 101, it is possible to prevent an image for the print job from being forming on the document M.

Further, the image forming apparatus 10 and the imaging terminal 20 are configured such that, when the imaging terminal 20 is placed on a predetermined imaging position on the image forming apparatus 10, the first communicator 16 and the second communicator 23 are connected via NFC. The first controller 11 is configured to, when the NFC is started, determine that the imaging terminal 20 is placed in the imaging position, and when NFC is disconnected, determine that the imaging terminal 20 is removed from the imaging position. Accordingly, it is possible to detect that the imaging terminal 20 is ready for imaging or not ready for imaging, in a simple way.

Further, the second controller 21 (image processor 213) trims the imaging data captured by the imager 22 according to the size of the imaged document M. Accordingly, appropriate imaging data that adequately represents the content of the document can be obtained.

Further, the second controller 21 (storage controller 214) stores the imaging data captured by the imager 22 in a predetermined storage provided outside the imaging terminal 20. Accordingly, even if there is not enough space in the storage 25 of the imaging terminal 20, imaging data can be appropriately stored. Also, since the imaging data can be stored in the storage desired by the user, the user convenience can be improved.

Further, the image forming apparatus 10 of the present embodiment includes: the conveyer 12; the manual feed tray 101; the conveyance controller 111; the image former 13; the first communicator 16; and the first controller 11; wherein the first controller 11 (first communication controller 113) causes the first communicator 16 to perform at least one of following: transmission of first information used for determining an imaging timing of the document M by the second controller 21 (imaging controller 211), to the second communicator 23; and transmission of second information used for determining a conveyance start timing of the document M by the first controller 11 (conveyance controller 111), from the second communicator 23. Since the image forming apparatus 10 is configured as described above, the document M can be imaged more appropriately by the imaging terminal 20.

Further, the imaging terminal 20 of the present embodiment includes: the imager 22; the second controller 21; and the second communicator 23; wherein the second controller 21 (second communication controller 212) causes the second communicator 23 to perform at least one of following: reception of first information used for determining an imaging timing of the document M by the second controller 21 (imaging controller 211), from the first communicator 16; and transmission of second information used for determining a conveyance start timing of the document M by the first controller 11 (conveyance controller 111), to the first communicator 16. With this configuration, the document M can be appropriately imaged more easily.

Further, the storage 19 of the present embodiment stores the program 191 that causes the first controller 11 included in the image forming apparatus 10 to perform a procedure including: causing the conveyer 12 to convey the plurality of documents M loaded on the manual feed tray 101 one by one; controlling an operation of the first communicator 16; and when the imaging terminal 20 images the plurality of documents, performing predetermined processing; wherein the processing causes the first communicator 16 to perform at least one of following: transmission of first information used for determining the imaging timing of the document M by the second controller 21, to the second communicator 23; and reception of second information used for determining a conveyance start timing of the document M by the first controller 11, from the second communicator 23. Since the image forming apparatus 10 operates according to this program, the document M can be imaged more appropriately by the imaging terminal 20.

Further, the storage 25 of the present embodiment stores the program 251 that causes the second controller 21 included in the imaging terminal 20 to perform a procedure including: causing the imager 22 to image the plurality of documents M loaded on the manual feed tray 101, one by one, in accordance with the timing at which the conveyer 12 conveys each of the documents M; controlling an operation of the second communicator 23; and when the plurality of documents are imaged, performing predetermined processing; wherein the processing causes the second communicator 23 to perform at least one of following: reception of first information used for determining the imaging timing of the document M by the second controller 21, from the first communicator 16; and transmission of second information used for determining a conveyance start timing of the document M by the first controller 11, to the first communicator 16. Since the imaging terminal 20 operates according to this program, the document M can be appropriately imaged more easily.

### Second Embodiment

In the following, a second embodiment of the present disclosure will be described. The present embodiment is different from the first embodiment in that, whereas an imaging timing by the imaging terminal 20 is determined based on control data (imaging trigger) transmitted from the image forming apparatus 10, control data (imaging completion notice) for determining a conveyance start timing of the document M is not transmitted from the imaging terminal 20 to the image forming apparatus 10. The following describes the differences from the first embodiment.

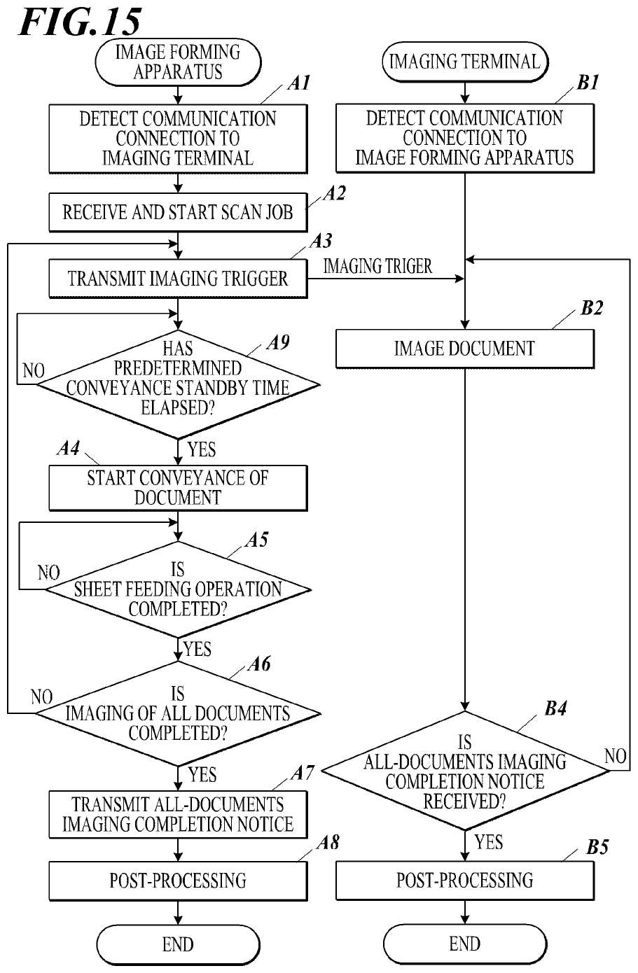

FIG. 15 is a flowchart illustrating the overview of a scan operation according to the second embodiment.

The flowchart of FIG. 15 corresponds to the flowchart of FIG. 4 with step B3 removed and step A9 added after step A3.

In a scan operation in the present embodiment, the image forming apparatus 10 transmits an imaging trigger in step A3. After that, if a predetermined conveyance standby time has elapsed (“YES” in step A9), the image forming apparatus 10 starts conveyance of the document M without waiting for reception of an imaging completion notice (step A4). Even if conveyance of the immediately preceding document M is not completed (not ejected to the sheet ejection tray 102), the conveyance of the next document M may be started when the conveyance standby time has elapsed. This can reduce the time taken to perform a scan operation.

The predetermined transport standby time is set to, for example, the time obtained by adding a predetermined margin to the time usually taken from transmission of an imaging trigger to completion of imaging of the document M by the imaging terminal 20. Conveyance of the document M is started after a lapse of the conveyance standby time from transmission of an imaging trigger. Accordingly, it is possible to prevent the document M from being conveyed before completion of imaging and hence being imaged inappropriately.

In the present embodiment, in the case of interrupting a scan job in response to detachment of the imaging terminal 20 from the adapter 103, the first controller 11 of the image forming apparatus 10 actively stops the subsequent processing after detection of disconnection of communication with the imaging terminal 20. This is because it is not possible to stop conveyance of the document M based on the fact that no imaging completion notice is received from the imaging terminal 20.

In this manner, in the imaging system 1 of the present embodiment, when the imaging terminal 20 images the plurality of documents M, an imaging trigger as the first information used for determining the imaging timing of the document M by the second controller 21 (imaging controller 211) is transmitted from the first communicator 16 to the second communicator 23. That is, the image forming apparatus 10 transmits various control data to the imaging terminal 20, and the imaging terminal 20 performs various types of processing in response to the control data. Even in this embodiment, it is possible to prevent the document M from being imaged inappropriately before completion of the sheet feeding operation of the preceding document M, and to prevent the document M from being conveyed before completion of imaging and hence being imaged inappropriately. Accordingly, the document M can be appropriately imaged more easily. Also, it is possible to simplify control performed by the imaging terminal 20.

### Third Embodiment

In the following, a third embodiment of the present disclosure will be described. The present embodiment is different from the first embodiment in that, whereas a conveyance start timing of the document M by the image forming apparatus 10 is determined based on control data (imaging completion notice) transmitted from the imaging terminal 20, control data (imaging trigger) for determining an imaging timing is not transmitted from the image forming apparatus 10 to the imaging terminal 20. The following describes the differences from the first embodiment.

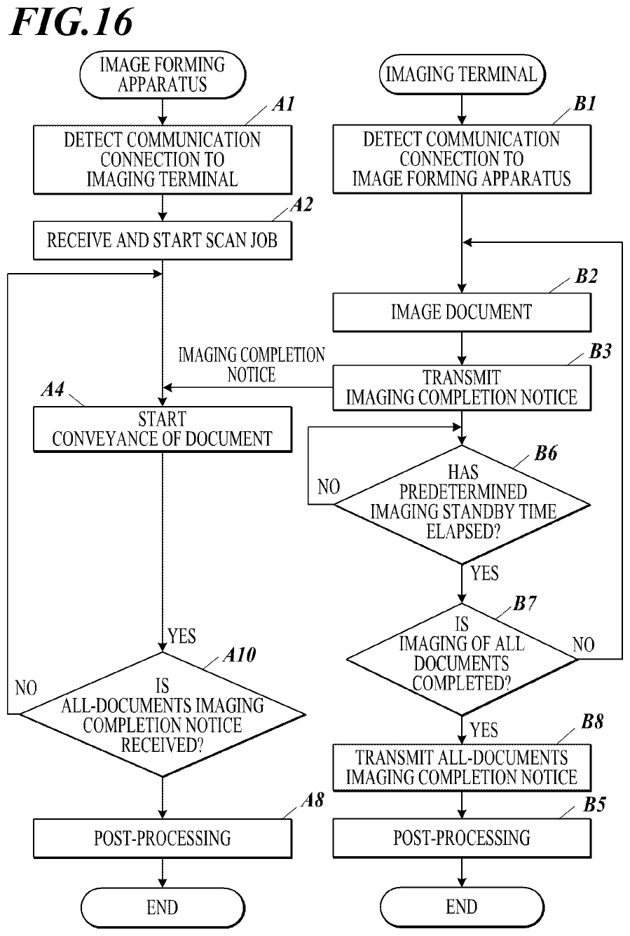

FIG. 16 is a flowchart illustrating the overview of a scan operation according to a third embodiment.

The flowchart of FIG. 16 corresponds to the flowchart of FIG. 4 with step A3, steps A5 to A7, and step B4 removed, step A10 added after step A4, and steps B6 to B8 added after step B3.

In a scan operation of the present embodiment, the imaging terminal 20 transmits an imaging completion notice in step B3. After that, if a predetermined imaging standby time has elapsed (“YES” in step B6), the imaging terminal 20 determines whether imaging of all the documents is completed (step B7). Specifically, the imaging terminal 20 performs imaging again in step B7, and determines whether another document M is imaged, or there is no document M and the surface of the manual feed tray 101 is imaged. If not all the document are imaged (“NO” in step B7), the imaging terminal 20 images the next document M without waiting for reception of an imaging trigger (step B2).

The predetermined imaging standby time is set to, for example, the time obtained by adding a predetermined margin to the time usually taken from transmission of an imaging completion notice to completion of a sheet feeding operation of the document M by the image forming apparatus 10. The next document M is imaged after a lapse of the imaging standby time from transmission of the imaging completion notice. This prevents the document M from being imaged inappropriately before completion of the feeding operation of the preceding document M (that is, while the preceding document M is still on the manual feed tray 101).

If imaging of all the documents is completed in step B7 (“YES” in B7), the imaging terminal 20 transmits an all-document imaging completion notice to the image forming apparatus 10 (step B8).

Meanwhile, the image forming apparatus 10 starts conveyance of a document in response to reception of an imaging completion notice (step A4), and thereafter determines whether an all-documents imaging completion notice is received (step A10). If an all-documents imaging completion notice is not received (“NO” in step A10), the image forming apparatus 10 conveys a document in response to reception of another imaging completion notice (step A4). If an all-documents imaging completion notice is received (“YES” in step A10), predetermined post-processing is executed (step A8).

In the present embodiment, in the case of interrupting a scan job in response to detachment of the imaging terminal 20 from the adapter 103, the second controller 21 of the imaging terminal 20 actively stops the subsequent processing after detection of disconnection of communication with the image forming apparatus 10. This is because it is not possible to stop conveyance of the document M based on the fact that no imaging trigger is received from the image forming apparatus 10.

In this manner, in the imaging system 1 of the present embodiment, when the imaging terminal 20 images the plurality of documents M, an imaging completion notice as the second information used for determining the conveyance start timing of the document M by the first controller 11 (conveyance controller 111) is transmitted from the second communicator 23 to the first communicator 16. That is, the imaging terminal 20 transmits various control data to the image forming apparatus 10, and the image forming apparatus 10 performs various types of processing in response to the control data. Even in this embodiment, it is possible to prevent the document M from being imaged inappropriately before completion of the sheet feeding operation of the preceding document M, and to prevent the document M from being conveyed before completion of imaging and hence being imaged inappropriately. Accordingly, the document M can be appropriately imaged more easily. Also, it is possible to simplify control performed by the image forming apparatus 10.

The present disclosure is not limited to the embodiments described above, and various modifications may be made.

For example, the present disclosure may be applied to an imaging system including a multifunction peripheral (MFP) having a function for scanning the document M and the imaging terminal 20.

Although the imaging terminal 20 has been illustrated as the imaging apparatus, the imaging apparatus is not limited to those implemented as terminal apparatus, and may be any apparatus that has an imager.

In the above embodiments, the imaging trigger has been illustrated as the first information. However, the present disclosure is not limited thereto. The first information may be any information used for determining the imaging timing of the document M by the imaging controller 211. For example, a predetermined imaging command for staring imaging control in the imaging terminal 20 may be transmitted as the first information.

In the above embodiments, the imaging completion notice has been illustrated as the second information. However, the present disclosure is not limited thereto. The second information may be any information used for determining the conveyance start timing of the document M by the conveyance controller 111. For example, a predetermined conveyance command for starting conveyance control in the image forming apparatus 10 and a print job for starting a blank sheet job may be transmitted as the second information.

In the above embodiments, damage to the document M by heat is prevented by stopping the heating operation of the heater 15 upon starting a scan job. However, the method of preventing damage to the document M by heat is not limited thereto. For example, in the case where the heater 15 is of a type that heats the recording medium m being conveyed through heat emission from a position near the recording medium m, damage to the document M by heat may be prevented by disposing the heat source of the heater 15 away from the conveyance path of the document M.

In the case where the vibration during conveyance by the conveyer 12 in the image forming apparatus 10 is large, an imaging trigger may be transmitted to the imaging terminal 20 when the vibration becomes small.

In the above embodiments, the operation display 18 of the image forming apparatus 10 receives user inputs for starting a scan job, and user inputs for specifying scan settings and copy settings. However, the present disclosure is not limited thereto. These user inputs may be received by the operation display 24 of the imaging terminal 20.

In the above embodiments, the image processor 213 of the imaging terminal 20 performs various types of image processing on image data. However, such image processing may be performed by an image processor provided in the image forming apparatus 10.

In the examples described above, the storage controller 214 of the imaging terminal 20 performs an operation for storing imaging data in a predetermined storage such as the storage 25, and an operation for integrating imaging data. However, these operations may be performed by a storage controller provided in the image forming apparatus 10.

In the above embodiments, when conveying the document M in a scan job, the conveyance controller 111 performs conveyance control. However, the present disclosure is not limited thereto. For example, the document M may be conveyed by executing a blank sheet job described above.

In the above embodiments, the storage 19 and the storage 25 have been illustrated as a computer-readable storage medium storing a program. However, the present disclosure is not limited thereto. For example, a portable storage medium such as a flash memory and a CD-ROM may be used.

Although some embodiments of the present disclosure have been described, the present disclosure is not limited to the above embodiments, and the scope of the present disclosure is defined by the appended claims and their equivalents.

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

What is claimed is:

1. An imaging system, comprising:
an image forming apparatus, including:
a conveyer that conveys a recording medium;
a sheet feeder on which a plurality of recording media to be fed to the conveyer is loaded such that the plurality of recording media is exposed to an outside;
a first hardware processor that causes the conveyer to convey the plurality of recording media loaded on the sheet feeder one by one;
an image former that forms an image on the recording medium being conveyed by the conveyer; and
a first communicator; and
an imaging apparatus, including:
an imager;
a second hardware processor that causes the imager to image a plurality of documents one by one in accordance with a timing at which the conveyer conveys each of the plurality of documents, the plurality of documents being the plurality of recording media loaded on the sheet feeder to be imaged; and
a second communicator that communicates with the first communicator;
wherein, when the imaging apparatus images the plurality of documents, the imaging system performs at least one of the following operations:
transmission of first information for determining an imaging timing of a document by the second hardware processor, from the first communicator to the second communicator; and
transmission of second information for determining a conveyance start timing of a document by the first hardware processor, from the second communicator to the first communicator.

2. The imaging system according to claim 1, wherein the first hardware processor is configured to cause the first communicator to transmit the first information to the second communicator in accordance with a timing at which the conveyer picks up the document from the sheet feeder, in which the first information indicates a pick-up status of the document from the sheet feeder, and
wherein the second hardware processor is configured to cause the imager to image a next document of the document picked up by the conveyer, in response to the first information.

3. The imaging system according to claim 1, wherein the second hardware processor is configured to cause the second communicator to transmit the second information to the first communicator, in response to completion of imaging of the document by the imager, and
wherein the first hardware processor is configured to cause the conveyer to pick up and convey the document that has been imaged by the imager, in response to the second information.

4. The imaging system according to claim 1, wherein the first hardware processor is configured to, when all of the plurality of documents has been picked up from the sheet feeder by the conveyer, cause the first communicator to transmit imaging completion information indicating completion of imaging of all of the plurality of documents to the second communicator.

5. The imaging system according to claim 1, wherein the image forming apparatus further includes a sheet ejector on which the plurality of recording media conveyed by the conveyer is placed, and
wherein the first hardware processor is configured to cause the conveyer to convey the document so that a side of the document imaged on the sheet feeder by the imager faces the sheet ejector, when the document is on the sheet ejector.

6. The imaging system according to claim 1, wherein the image forming apparatus further includes a sheet ejector on which the plurality of recording media conveyed by the conveyer is placed, and
wherein the first hardware processor is configured to, before the document being conveyed by the conveyer is placed on the sheet ejector, cause the conveyer to start conveyance of a next document.

7. The imaging system according to claim 1, wherein the first hardware processor is configured to stop conveyance of a next document by the conveyer, in response to detection of a disconnection of communication between the first communicator and the second communicator.

8. The imaging system according to claim 1, wherein the image forming apparatus further includes a heater that heats the recording medium to fix the image formed on the recording medium, and
wherein the first hardware processor is configured to:
when the imaging apparatus images the plurality of documents, control the heater such that a heating temperature of the heater for heating the document satisfies a predetermined low temperature condition; and
after the heating temperature of the heater for heating the document satisfies the low temperature condition, cause the conveyer to pick up and convey the document that has been imaged by the imager.

9. The imaging system according to claim 8, wherein the first hardware processor is configured to stop a heating operation of the heater when the imaging apparatus images the plurality of documents.

10. The imaging system according to claim 9, wherein the first hardware processor is configured to, when a scan command for imaging of the document by the imaging apparatus is interrupted and the interruption satisfies a predetermined long interruption condition, restart the heating operation of the heater.

11. The imaging system according to claim 1, wherein the first hardware processor is configured to receive and manage (i) an imaging command for imaging of the document by the imaging apparatus and (ii) an image formation command for image formation on the recording medium by the image former, and
wherein the first hardware processor or the second hardware processor is configured to, when the first hardware processor detects an interruption of the imaging command, store obtained imaging data in a predetermined storage, and when the first hardware processor detects resumption of the imaging command, integrate the imaging data stored in the storage and imaging data obtained after the resumption of the imaging command

12. The imaging system according to claim 1, wherein the first hardware processor is configured to:
receive and manage (i) an imaging command for imaging of the document by the imaging apparatus and (ii) an image formation command for image formation on the recording medium by the image former; and
when the first hardware processor detects an interruption of the imaging command and when the interruption satisfies a predetermined long interruption condition, accept the image formation command to form an image on the recording medium that is fed through a path not passing through the sheet feeder.

13. The imaging system according to claim 1, wherein the first hardware processor is configured to:
receive and manage (i) an imaging command for imaging of the document by the imaging apparatus and (ii) an image formation command for image formation on the recording medium by the image former; and
after communication between the first communicator and the second communicator is started, when there is an uncompleted image formation command to form an image on the recording medium fed from the sheet feeder and when no recording medium is detected on the sheet feeder, interrupt the image formation command until the imaging command is completed.

14. The imaging system according to claim 1, wherein the image forming apparatus and the imaging apparatus are configured such that, when the imaging apparatus is placed on a predetermined imaging position on the image forming apparatus, the first communicator and the second communicator are connected via near field communication, and
wherein the first hardware processor is configured to, in response to the near field communication being started, determine that the imaging apparatus is placed in the imaging position, and in response to the near field communication being disconnected, determine that the imaging apparatus is removed from the imaging position.

15. The imaging system according to claim 1, wherein the first hardware processor or the second hardware processor trims imaging data captured by the imager according to a size of the imaged document.

16. The imaging system according to claim 1, wherein the first hardware processor or the second hardware processor stores imaging data captured by the imager in a predetermined external storage provided outside the imaging apparatus.

17. An image forming apparatus comprising:
a conveyer that conveys a recording medium;
a sheet feeder on which a plurality of recording media to be fed to the conveyer is loaded such that the plurality of recording media is exposed to an outside;
a first hardware processor that causes the conveyer to convey the plurality of recording media loaded on the sheet feeder one by one;
an image former that forms an image on the recording medium being conveyed by the conveyer; and
a first communicator,
wherein the image forming apparatus is communicably connectable to an imaging apparatus,
wherein the imaging apparatus includes:
an imager;
a second hardware processor that causes the imager to image a plurality of documents one by one in accordance with a timing at which the conveyer conveys each of the plurality of documents, the plurality of documents being the plurality of recording media loaded on the sheet feeder to be imaged; and
a second communicator that communicates with the first communicator, and
wherein the first hardware processor is configured to:
control the first communicator; and
when the imaging apparatus images the plurality of documents, cause the first communicator to perform at least one of the following operations:
transmission of first information for determining an imaging timing of the document by the second hardware processor, to the second communicator; and
reception of second information for determining a conveyance start timing of the document by the first hardware processor, from the second communicator.

18. An imaging apparatus that is communicably connectable to an image forming apparatus, wherein the image forming apparatus includes: a conveyer that conveys a recording medium; a sheet feeder on which a plurality of recording media to be fed to the conveyer is loaded such that the plurality of recording media is exposed to an outside; a first hardware processor that causes the conveyer to convey the plurality of recording media loaded on the sheet feeder one by one; an image former that forms an image on the recording medium being conveyed by the conveyer; and a first communicator, the imaging apparatus comprising:
an imager;
a second hardware processor that causes the imager to image a plurality of documents one by one in accordance with a timing at which the conveyer conveys each of the plurality of documents, the plurality of documents being the plurality of recording media loaded on the sheet feeder to be imaged; and
a second communicator that communicates with the first communicator;
wherein the second hardware processor is configured to:
control the second communicator; and
when the plurality of documents are imaged, cause the second communicator to perform at least one of the following operations:
reception of first information for determining an imaging timing of a document by the second hardware processor, from the first communicator; and
transmission of second information for determining a conveyance start timing of a document by the first hardware processor, to the first communicator.

19. A non-transitory computer-readable storage medium storing a program to be executed by a first hardware processor of an image forming apparatus,
wherein the image forming apparatus includes: the first hardware processor; a conveyer that conveys a recording medium; a sheet feeder on which a plurality of recording media to be fed to the conveyer is loaded such that the plurality of recording media is exposed to the outside; an image former that forms an image on the recording medium being conveyed by the conveyer; and a first communicator, and
wherein the image forming apparatus is communicably connectable to an imaging apparatus,
wherein the imaging apparatus includes: an imager; a second hardware processor that causes the imager to image a plurality of documents one by one in accordance with a timing at which the conveyer conveys each of the plurality of documents, the plurality of documents being the plurality of recording media loaded on the sheet feeder to be imaged; and a second communicator that communicates with the first communicator,
wherein the program causes the first hardware processor to perform:
causing the conveyer to convey the plurality of recording media loaded on the sheet feeder one by one;
controlling the first communicator; and
when the imaging apparatus images the plurality of documents, performing predetermined processing, and
wherein the processing causes the first communicator to perform at least one of following operations:
transmission of first information for determining an imaging timing of a document by the second hardware processor, to the second communicator; and
reception of second information for determining a conveyance start timing of a document by the first hardware processor, from the second communicator.

20. A non-transitory computer-readable storage medium storing a program to be executed by a second hardware processor of an imaging apparatus,
wherein the imaging apparatus includes: the second hardware processor; an imager; and a second communicator,
wherein the imaging apparatus is communicably connectable to an image forming apparatus,
wherein the image forming apparatus includes: a conveyer that conveys a recording medium; a sheet feeder on which a plurality of recording media to be fed to the conveyer is loaded such that the plurality of recording media is exposed to an outside; a first hardware processor that causes the conveyer to convey the plurality of recording media loaded on the sheet feeder one by one; an image former that forms an image on the recording medium being conveyed by the conveyer; and a first communicator that communicates with the second communicator,
wherein the program causes the second hardware processor to perform:
causing the imager to image a plurality of documents one by one in accordance with a timing at which the conveyer conveys each of the plurality of documents, the plurality of documents being the plurality of recording media loaded on the sheet feeder to be imaged;
controlling the second communicator; and
when the plurality of documents are imaged, performing predetermined processing, and
wherein the processing causes the second communicator to perform at least one of the following operations:
reception of first information for determining an imaging timing of a document by the second hardware processor, from the first communicator; and
transmission of second information for determining a conveyance start timing of a document by the first hardware processor, to the first communicator.
